(19) United States
(12) Patent Application Publication
(10) Pub. No.: US 2026/0308400 A1
(43) Pub. Date: Oct. 8, 2026

(54) ADSORPTIVE COATINGS FOR METAL SURFACES AND RELATED METHODS

(71) Applicant: Research Triangle Institute, Research Triangle Park, NC (US)

(72) Inventors: Paban Sitaula, Morrisville, NC (US); Mustapha Soukri, Cary, NC (US); Jeffrey Mecham, Chapel Hill, NC (US)

(21) Appl. No.: 19/479,475

(22) PCT Filed: Apr. 30, 2024
(86) PCT No.: PCT/US2024/026961

§ 371 Date: Oct. 28, 2025

Related U.S. Application Data
(60) Provisional application No. 63/463,274, filed on May 1, 2023.

(51) Int. Cl. C09D 7/63; B05D 3/02; B05D 3/10; B05D 3/12; C09D 163/00

(52) U.S. Cl. CPC C09D 7/63; B05D 3/0254; B05D 3/108; B05D 3/12; C09D 163/00; B05D 2202/15; B05D 2504/00

(57) ABSTRACT

Curable coating compositions and methods of coating the surfaces of objects, such as metal objects, are described. The coating compositions can include organic and/or inorganic solid adsorbent agents and provide durable cured coating layers on metal object surfaces that can be used to adsorb select molecules, such as carbon dioxide or water.

### CROSS-REFERENCE TO RELATED APPLICATION

This application claims the benefit of priority of U.S. provisional patent application No. 63/463,274 titled “ADSORPTIVE COATINGS FOR METAL SURFACES AND RELATED METHODS” filed May 1, 2023, which is incorporated herein by its entirety by this reference.

### GOVERNMENT SUPPORT

This invention was made with government support under DE-FE0032099 awarded by the U.S. Department of Energy. The government has certain rights in the invention.

### TECHNICAL FIELD

The presently disclosed subject matter relates to curable and cured coating compositions (e.g., for metal surfaces) and to methods of coating surfaces with the curable coating compositions. The coating compositions can include organic materials and inorganic materials which can be selected to provide desirable surface/coating properties or functionality, such as desirable porosity and an ability to capture/adsorb select molecules. Exemplary coating compositions include adsorptive agents, such as polyamine-based phosphorous dendrimers (P-dendrimers) for carbon dioxide capture or metal-organic frameworks (MOFs) for water adsorption. The presently disclosed subject matter further relates to methods of using the presently disclosed coated surfaces for carbon capture or for harvesting water from air.

### BACKGROUND

Coating processes generally involve the deposition of organic and/or inorganic materials on surfaces (such as surfaces of metal rods or sheets, paper, or other objects). For instance, it can be desirable to coat different materials on the surface of other objects in a uniform manner, e.g., in uniform patterns and/or thicknesses. Surface coatings can be desirable for a variety of reasons, including to provide corrosion protection and/or to provide good aesthetics. The selection of particular coating materials can depend on various parameters, for example, the shape of the surface to be coated; desired frictional properties, hydrophilicity, thermal and/or electrical properties; and the cost and availability of the coating materials. Coating materials can be either pigmented or unpigmented and can preferably be used to form films of desirable thicknesses. Generally, it can be desirable for coated surfaces to have good durability, e.g., thus resulting in minimized loss of functionality and/or dimensions.

Recently, coating materials and processes have gained attention in the preparation of adsorbent coatings, such as for use in carbon capture technology, water harvesting, and various other chemical separation/purification applications. For instance, to provide carbon capture, it can be desirable to deposit or coat materials capable of adsorbing carbon dioxide on metal plates arranged in a designed architecture to adsorb carbon dioxide selectively from a gaseous mixture, e.g., mixed gas streams, flue gas, or ambient air. Materials that can adsorb water can be used for atmospheric water harvesting, i.e., to adsorb water vapor from the air so that it can be later released and reclaimed as liquid water, an application of particular interest in arid locations.

Accordingly, there is an ongoing need for additional coating formulations and processes, particularly for coating surfaces with materials that can selectively capture or adsorb select molecules such as carbon dioxide or water.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features. In some embodiments, the presently disclosed subject matter provides a curable coating composition comprising: (a) a solid adsorbent agent; (b) a liquid carrier; and (c) a curable binder. In some embodiments, the curable binder comprises an epoxy resin. In some embodiments, the epoxy resin comprises a cycloaliphatic epoxy resin. In some embodiments, the curable binder further comprises a diamine. In some embodiments, the curable binder further comprises an epoxy modifier selected from the group comprising an epoxy-functionalized alcohol, an epoxy-functionalized diol, an epoxy-functionalized polyol, and an epoxy-functionalized carboxylic acid. In some embodiments, the curable binder further comprises an epoxy-functionalized silane.

In some embodiments, the liquid carrier is a polar organic solvent. In some embodiments, the polar organic solvent is isopropanol.

In some embodiments, the solid adsorbent agent is a polyamine-based phosphorous dendrimer (P-dendrimer). In some embodiments, the polyamine-based P-dendrimer is based on a polyamine selected from the group comprising molecular weight (MW) 800 branched polyethyleneimine (PEI); MW 600 branched PEI; MW 1200 branched PEI; MW 2500 branched PEI; MW 10000 branched PEI; MW 600 linear PEI; tetraethylenepentamine; triethylenebutamine; diethylenetriamine; 1,2-diaminoethane; 1,2-diaminopropane; and 2,2′,2″-triaminotriethylamine.

In some embodiments, the solid adsorbent agent is a metal-organic framework (MOF). In some embodiments, the MOF is selected from the group comprising MOF-801, MOF-808, MOF-841, MOF-303, MOF-333, NbOFFIVE-1-Ni, FeFFIVE-1-Ni, and AlFFIVE-1-Ni.

In some embodiments, the curable coating composition comprises at least about 5 weight percent (wt %) of the curable binder compared to the weight of the solid adsorbent agent. In some embodiments, the curable coating composition comprises about 5 wt % of the curable binder to about 45 wt % of the curable binder compared to the weight of the solid adsorbent agent.

In some embodiments, the curable coating composition further comprises a porosity control agent. In some embodiments, the porosity control agent comprises an inorganic solid additive that can decompose during heating at a temperature suitable for curing the curable binder solution. In some embodiments, the porosity control agent comprises one or more of ammonium carbonate and ammonium bicarbonate. In some embodiments, the porosity control agent comprises carbamate groups formed between carbon dioxide gas and reactive amine groups in a polyamine-based P-dendrimer or another curable coating composition component comprising the reactive amine groups.

In some embodiments, the presently disclosed subject matter provides a method of preparing a curable coating composition, the method comprising: (a) preparing a slurry comprising a solid adsorbent agent and a liquid carrier; (b) preparing a curable binder; and (c) contacting the curable binder with the slurry to provide the curable coating composition. In some embodiments, preparing the slurry comprises contacting the solid adsorbent agent with the liquid carrier and stirring the resulting mixture for a period of time. In some embodiments, the slurry comprises a weight-to-weight ratio of solid adsorbent agent to liquid carrier of about 1:2 to about 1:3.

In some embodiments, preparing the curable binder comprises mixing an epoxy resin with one or more of an epoxy modifier, a diamine, and an epoxy-functionalized silane. In some embodiments, contacting the curable binder with the slurry comprises adding the curable binder to the slurry and stirring the resulting composition for a period of time. In some embodiments, the contacting comprises contacting the slurry with an amount of curable binder having a weight of at least about 5% of the weight of the solid adsorbent agent in the slurry.

In some embodiments, the method further comprises incorporating a porosity control agent in the curable coating composition. In some embodiments, the porosity control agent comprises an inorganic solid additive, wherein the inorganic solid additive is capable of decomposing upon heating to a temperature suitable for curing the curable binder, and wherein incorporating the porosity control agent comprises adding the inorganic solid additive to the curable coating composition, optionally wherein said inorganic solid additive comprises one or more of the group comprising ammonium carbonate and ammonium bicarbonate. In some embodiments, the solid adsorbent agent comprises a polyamine-based P-dendrimer comprising reactive amine groups, and incorporating a porosity control agent comprises bubbling carbon dioxide gas into the slurry prepared in step (a); wherein the carbon dioxide reacts with reactive amine groups to form carbamate groups that can decompose to reform carbon dioxide gas upon heating to a temperature suitable for curing the curable binder solution.

In some embodiments, the presently disclosed subject matter provides a method of coating a metal object, the method comprising: (i)

providing a curable coating composition of the presently disclosed subject matter; (ii) pre-treating one or more surfaces of a metal object to provide one or more pre-treated surfaces, wherein the pre-treating comprises cleaning, treating with an abrasive, and/or applying a primer; (iii) applying the coating composition to the one or more pre-treated surfaces, thereby providing one or more treated surfaces; and (iv) curing said curable coating composition, thereby providing a metal object comprising one or more surfaces comprising a solid coating layer. In some embodiments, step (ii) comprises washing said one or more surfaces of said metal object with acetone and/or isopropanol. In some embodiments, step (ii) comprises applying a primer to said one or more surfaces of said metal object, optionally wherein the primer is an epoxy primer, and curing the primer. In some embodiments, step (iv) is performed by heating the one or more treated surfaces to a temperature of about 60° C. to about 130° C. for about 30 minutes to about 5 hours. In some embodiments, the metal object is a metal sheet or plate, optionally a stainless-steel sheet or plate.

In some embodiments, the presently disclosed subject matter provides a metal object comprising one or more surfaces comprising a solid coating layer prepared according to a method described herein.

In some embodiments, the presently disclosed subject matter provides a metal object comprising one or more surfaces coated with a solid coating layer comprising an adsorbent agent entrapped in a polymeric matrix, wherein said adsorbent agent is a polyamine-based P-dendrimer or a metal-organic framework (MOF), and wherein said polymeric matrix is a cured epoxy resin. In some embodiments, the coating layer is porous. In some embodiments, the solid coating layer has a thickness of about 0.01 millimeters (mm) to about 1.0 mm.

In some embodiments, the presently disclosed subject matter provides a method of adsorbing carbon dioxide from a gaseous fluid, the method comprising contacting a gaseous fluid comprising carbon dioxide with a coated object, wherein the coated object comprises a metal object comprising one or more surfaces comprising a solid coating layer, said solid coating layer comprising a polyamine-based P-dendrimer encapsulated in a polymeric matrix. In some embodiments, the metal object is a metal sheet or plate, optionally a stainless-steel sheet or plate. In some embodiments, the polymeric matrix comprises an epoxy.

In some embodiments, the solid coating layer has a thickness of about 0.01 millimeters (mm) to about 1.0 mm, optionally about 0.1 mm to about 1.0 mm. In some embodiments, polyamine-based P-dendrimer in the solid coating layer has a CO₂ adsorption capacity of about 78% compared to a same amount of free polyamine-based P-dendrimer.

In some embodiments, the presently disclosed subject matter provides a method of adsorbing water from a gaseous fluid, the method comprises: (i) providing a metal object comprising one or more surfaces comprising a solid coating layer, said solid coating layer comprising a metal-organic framework (MOF) encapsulated in a polymeric matrix; (ii) heating the metal object to about 100° C. under a nitrogen environment; and (iii) contacting a gaseous fluid comprising water vapor with the metal object. In some embodiments, the MOF is selected from the group comprising MOF-801, MOF-808, MOF-841, MOF-303, MOF-333, NbOFFIVE-1-Ni, FeOFFIVE-1-Ni, and AlOFFIVE-1-Ni. In some embodiments, the MOF is MOF-801 and the coating layer has a water adsorption capacity of about 20% to about 50% on a weight-by-weight basis compared to the weight of MOF in the coating layer.

Accordingly, it is an object of the presently disclosed subject matter to provide curable coating compositions, objects coated therewith, methods of preparing the curable coating compositions, methods of coating metal surfaces, and methods of capturing carbon dioxide or water from a gaseous fluid.

Certain objects of the presently disclosed subject matter having been stated hereinabove, which are addressed in whole or in part by the presently disclosed subject matter, other objects and aspects will become evident as the description proceeds when taken in connection with the accompanying Examples as best described herein below.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter. The drawings are not intended to limit the scope of this presently disclosed subject matter, which is set forth with particularity in the claims as appended or as subsequently amended, but merely to clarify and exemplify the presently disclosed subject matter.

For a more complete understanding of the presently disclosed subject matter, reference is now made to the below drawings.

FIG. 1 is a composite photographic image showing metal plates coated with a coating layer prepared from a curable coating composition comprising a polyamine-based phosphorous dendrimer (P-dendrimer) adsorbent agent and an epoxy-based binder solution (BS). The amount of BS in the curable coating composition was varied from 15 percent (15%) by weight of the P-dendrimer (upper left), to 20% (upper right), to 30% (lower left) to 45% (lower right).

FIG. 2 is (top) a schematic diagram of a process for pre-treating the surface of a metal substrate prior to coating with a curable coating composition and (bottom) a schematic with photographic images showing a process for coating a surface according to the presently disclosed subject matter, including a sanding/primer application pre-treatment and coating with a curable coating composition.

FIGS. 3A-3F are a series of micrograph images of (FIGS. 3A-3C) a polyamine-based phosphorous dendrimer (P-dendrimer) adsorbent agent and (FIGS. 3D-3F) a coating formed by curing a curable coating composition comprising P-dendrimer and an epoxy-based binder solution (BS) where the amount of BS was 30 percent (30%) by weight of the P-dendrimer. The scale bar at the lower right of FIG. 3A represents 50 micrometers (μm), while the scale bar at the lower right of FIG. 3B represents 20 μm and the scale bar at the lower right of FIG. 3C represents 5 μm. The scale bar at the lower right of FIG. 3D represents 200 μm, the scale bar at the lower right of FIG. 3E represents 20 μm, and the scale bar at the lower right of FIG. 3F represents 5 μm.

FIG. 4 is a graph showing the infrared (IR) spectra of a cured coating layer formed from a curable coating composition comprising a polyamine-based phosphorous dendrimer (P-dendrimer) and varying amounts of an epoxy-based binder solution (BS) (15 percent (%), 20%, 30%, or 45% by weight of the p-dendrimer). For comparison, the spectrum of the P-dendrimer alone is also shown.

FIGS. 5A and 5B are a pair of graphs showing carbon dioxide (CO₂) isotherms (quantity adsorbed (in cubic centimeters per gram at standard temperature and pressure (cc/g STP) versus absolute pressure (in millimeters mercury (mmHg)). FIG. 5A is the isotherm for a polyamine-based phosphorous dendrimer (P-dendrimer), while FIG. 5C is the isotherm for a coating formed from a coating composition comprising the P-dendrimer and 30 percent (%) of an epoxy-based binder solution (BS) by weight of the P-dendrimer.

FIG. 6 is a graph showing the time-resolved sorption of carbon dioxide (CO₂) at 75% relative humidity (RH) (i.e., as mass (measured as weight percent (wt. %) versus time in hours) for a polyamine-based phosphorous dendrimer (P-dendrimer) and for a coating prepared by curing a coating composition comprising the P-dendrimer and 30 percent (%) epoxy-based binder solution (BS) by weight of the P-dendrimer.

FIG. 7 is a photographic image of a substrate coated with a coating formed from a curable coating composition comprising a polyamine-based phosphorous dendrimer (P-dendrimer), an epoxy-based binder solution (BS), and a solid additive for porosity control. More particularly, the image shows a coating prepared from a composition comprising ammonium carbonate with 40% BS by weight of the P-dendrimer. The coating was cured at 65 degrees Celsius (° C.) for 4 hours.

FIG. 8 is a series of scanning electron microscopy (SEM) images of a coating obtained by bubbling carbon dioxide (CO₂) in an isopropanol (IPA)-polyamine-based phosphorous dendrimer slurry prior to mixing it with an epoxy-based binder solution (BS) and curing the resulting curable coating composition. The magnification of the images increases from left to right.

FIG. 9 is a series of images of a metal-organic framework (MOF) adsorbent agent, i.e., MOF-801, and of a coating material comprising the MOF. The image on the left is a photographic image of a coated plate prepared with a MOF-801-containing coating layer according to a method of the presently disclosed subject matter. The image in the middle is a scanning electron microscopy (SEM) image of pristine MOF-801. The image on the right is an SEM image of the coating layer prepared from a curable coating composition of the presently disclosed subject matter comprising MOF-801.

FIG. 10 is a series of images of a niobium metal-organic framework (Nb-MOF) adsorbent agent and of a coating material comprising Nb-MOF. The image on the left is a photographic image of a coated plate prepared with an Nb-MOF-containing coating layer according to a method of the presently disclosed subject matter. The image in the middle is a scanning electron microscopy (SEM) image of pristine Nb-MOF. The image on the right is an SEM image of the coating layer prepared from a curable coating composition of the presently disclosed subject matter that comprises Nb-MOF.

FIGS. 11A and 11B are graphs of the Intelligent gravimetric analysis (IGA) of a cured coating layer of the presently disclosed subject matter comprising a metal-organic framework (MOF), i.e., MOF-801, as the adsorbent agent. FIG. 11A is a graph showing the time-resolved sorption of water vapor (i.e., as mass (measured as weight percent (wt. %) versus time in minutes (min)). FIG. 11B is a graph showing an increase in mass (expressed as (wt %) as a function of relative humidity (RH; expressed as a percentage (%)).

### DETAILED DESCRIPTION

The presently disclosed subject matter will now be described more fully hereinafter with reference to the accompanying Figures and Examples, in which representative embodiments are shown. The presently disclosed subject matter can, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which this presently described subject matter belongs. All publications, patent applications, patents, and other references mentioned herein are incorporated by reference in their entirety.

Throughout the specification and claims, a given chemical formula or name shall encompass all optical and stereoisomers, as well as racemic mixtures where such isomers and mixtures exist, unless otherwise specifically indicated.

### 1. Definitions

Following long-standing patent law convention, the terms “a”, “an”, and “the” refer to “one or more” when used in this application, including the claims. Thus, for example, reference to “a solvent” includes mixtures of one or more solvents, two or more solvents, and the like.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in the present specification and attached claims are approximations that can vary depending upon the desired properties sought to be obtained by the presently disclosed subject matter.

The term “about”, as used herein when referring to a measurable value such as an amount of weight, molar equivalents, time, temperature, etc. is meant to encompass in one example variations of ±20% or ±10%, in another example ±5%, in another example ±1%, and in yet another example ±0.1% from the specified amount, as such variations are appropriate to perform the disclosed methods.

The term “and/or” when used to describe two or more activities, conditions, or outcomes refers to situations wherein both of the listed conditions are included or wherein only one of the two listed conditions are included.

The term “comprising”, which is synonymous with “including,” “containing,” or “characterized by” is inclusive or open-ended and does not exclude additional, unrecited elements or method steps. “Comprising” is a term of art used in claim language, which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein the term “alkyl” refers to C1-C20 inclusive, linear (i.e., “straight-chain”), branched, or cyclic, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and allenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C1-C8 alkyl), e.g., 1, 2, 3, 4, 5, 6, 7, or 8 carbon atoms. In some embodiments, “lower alkyl” can refer to C1-C6 or C1-C5 alkyl groups. “Higher alkyl” refers to an alkyl group having about 10 to about 20 carbon atoms, e.g., 10, 11, 12, 13, 14, 15, 16, 17, 18, 19, or 20 carbon atoms. In certain embodiments, “alkyl” refers, in particular, to C1-C8 or C1-C6 straight-chain or branched-chain alkyls.

Alkyl groups can optionally be substituted (a “substituted alkyl”) with one or more alkyl group substituents, which can be the same or different. The term “alkyl group substituent” includes but is not limited to alkyl, substituted alkyl, halo, nitro, cyano, amino, arylamino, acyl, hydroxyl, aryloxyl, alkoxyl, alkylthio, arylthio, aralkyloxyl, aralkylthio, carboxyl, alkoxycarbonyl, oxo, and cycloalkyl. There can be optionally inserted along the alkyl chain one or more oxygen, sulfur or substituted or unsubstituted nitrogen atoms, wherein the nitrogen substituent is hydrogen, lower alkyl (also referred to herein as “alkylaminoalkyl”), or aryl.

Thus, as used herein, the term “substituted alkyl” includes alkyl groups, as defined herein, in which one or more atoms or functional groups of the alkyl group are replaced with another atom or functional group, including for example, alkyl, substituted alkyl, halogen, aryl, substituted aryl, alkoxyl, hydroxyl, nitro, cyano, amino, alkylamino, dialkylamino, ester, acyl, amide, sulfonyl, sulfate, and mercapto.

The term “alkenyl” refers to an alkyl group as defined above including at least one carbon-carbon double bond. Exemplary alkenyl groups include, but are not limited to, ethenyl, propenyl, butenyl, pentenyl, hexenyl, octenyl, butadienyl, and allenyl groups. Alkenyl groups can optionally be substituted with one or more alkyl group substitutents, which can be the same or different, including, but not limited to alkyl (saturated or unsaturated), substituted alkyl (e.g., halo-substituted and perhalo-substituted alkyl, such as but not limited to, —CF₃), cycloalkyl, halo, nitro, hydroxyl, carbonyl, carboxyl, acyl, alkoxyl, aryloxyl, aralkoxyl, thioalkyl, thioaryl, thioaralkyl, amino (e.g., aminoalkyl, aminodialkyl, aminoaryl, etc.), sulfonyl, and sulfinyl.

“Cyclic” and “cycloalkyl” refer to a non-aromatic mono- or multicyclic ring system of about 3 to about 10 carbon atoms, e.g., 3, 4, 5, 6, 7, 8, 9, or 10 carbon atoms. In some embodiments, the cycloalkyl ring system comprises between 3 and 6 carbon atoms. The cycloalkyl group can be optionally partially unsaturated. The cycloalkyl group also can be optionally substituted with an alkyl group substituent as defined herein. There can be optionally inserted along the cyclic alkyl chain one or more oxygen, sulfur or substituted or unsubstituted nitrogen atoms, wherein the nitrogen substituent is hydrogen, alkyl, substituted alkyl, aryl, or substituted aryl, thus providing a heterocyclic group. Representative monocyclic cycloalkyl rings include, but are not limited to, cyclopropyl, cyclobutyl, cyclopentyl, cyclohexyl, cycloheptyl, and the like. Further, the cycloalkyl group can be optionally substituted with a linking group, such as an alkylene group as defined hereinbelow, for example, methylene, ethylene, propylene, and the like. In such cases, the cycloalkyl group can be referred to as, for example, cyclopropylmethyl, cyclobutylmethyl, and the like. Additionally, multicyclic cycloalkyl rings include adamantyl, octahydronaphthyl, decalin, camphor, camphane, and noradamantyl.

Thus, as used herein, the term “substituted cycloalkyl” includes cycloalkyl groups, as defined herein, in which one or more atoms or functional groups of the cycloalkyl group are replaced with another atom or functional group, including for example, alkyl, substituted alkyl, halogen, aryl, substituted aryl, alkoxyl, hydroxyl, nitro, cyano, amino, alkylamino, dialkylamino, ester, acyl, amide, sulfonyl, sulfate, and mercapto.

The term “aryl” is used herein to refer to an aromatic substituent that can be a single aromatic ring, or multiple aromatic rings that are fused together, linked covalently, or linked to a common group, such as, but not limited to, a methylene or ethylene moiety. The common linking group also can be a carbonyl, as in benzophenone, or oxygen, as in diphenylether, or nitrogen, as in diphenylamine. The term “aryl” specifically encompasses heterocyclic aromatic compounds (i.e., “heteroaryl”). The aromatic ring(s) can comprise phenyl, naphthyl, biphenyl, diphenylether, diphenylamine and benzophenone, among others. In particular embodiments, the term “aryl” means a cyclic aromatic comprising about 5 to about 10 carbon atoms, e.g., 5, 6, 7, 8, 9, or 10 carbon atoms, and including 5- and 6-membered hydrocarbon and heterocyclic aromatic rings.

The aryl group can be optionally substituted (a “substituted aryl”) with one or more aryl group substituents, which can be the same or different, wherein “aryl group substituent” includes alkyl, substituted alkyl, aryl, substituted aryl, aralkyl, hydroxyl, alkoxyl, aryloxyl, aralkyloxyl, carboxyl, acyl, halo, nitro, alkoxycarbonyl, aryloxycarbonyl, aralkoxycarbonyl, acyloxyl, acylamino, aroylamino, carbamoyl, alkylcarbamoyl, dialkylcarbamoyl, arylthio, alkylthio, alkylene, and —NR′R″, wherein R′ and R″ can each be independently hydrogen, alkyl, substituted alkyl, aryl, substituted aryl, and aralkyl.

Thus, as used herein, the term “substituted aryl” includes aryl groups, as defined herein, in which one or more atoms or functional groups of the aryl group are replaced with another atom or functional group, including for example, alkyl, substituted alkyl, halogen, aryl, substituted aryl, alkoxyl, hydroxyl, nitro, amino, alkylamino, dialkylamino, sulfate, and mercapto.

Specific examples of aryl groups include, but are not limited to, cyclopentadienyl, phenyl, furan, thiophene, pyrrole, pyridine, imidazole, benzimidazole, isothiazole, isoxazole, pyrazole, pyrazine, triazine, thiazole, pyrimidine, quinoline, isoquinoline, indole, carbazole, napthyl, and the like.

“Heterocyclic”, “heterocycle”, or “heterocyclo” as used herein alone or as part of another group, refers to an aliphatic (e.g., fully or partially saturated heterocyclo) or aromatic (e.g., heteroaryl) monocyclic- or a bicyclic-ring system comprising one or more heteroatoms (e.g., 1, 2, or 3 heteroatoms selected from oxygen, sulfur, and substituted or unsubstituted nitroten) inserted along the cyclic alkyl or aryl carbon chain. Monocyclic ring systems are exemplified by any 5- or 6-membered ring containing 1, 2, 3, or 4 heteroatoms independently selected from oxygen, nitrogen and sulfur. The 5 membered ring has from 0-2 double bonds and the 6 membered ring has from 0-3 double bonds. Representative examples of monocyclic ring systems include, but are not limited to, ethylene oxide, azetidine, azepine, aziridine, diazepine, 1,3-dioxolane, dioxane, dithiane, furan, imidazole, imidazoline, imidazolidine, isothiazole, isothiazoline, isothiazolidine, isoxazole, isoxazoline, isoxazolidine, morpholine, oxadiazole, oxadiazoline, oxadiazolidine, oxazole, oxazoline, oxazolidine, piperazine, piperidine, pyran, pyrazine, pyrazole, pyrazoline, pyrazolidine, pyridine, pyrimidine, pyridazine, pyrrole, pyrroline, pyrrolidine, tetrahydrofuran, tetrahydropyran, tetrahydrothiophene (also known as thiolane), tetrazine, tetrazole, thiadiazole, thiadiazoline, thiadiazolidine, thiazole, thiazoline, thiazolidine, thiophene, thiomorpholine, thiomorpholine sulfone, thiopyran, triazine, triazole, trithiane, and the like. Bicyclic ring systems are exemplified by any of the above monocyclic ring systems fused to an aryl group as defined herein, a cycloalkyl group as defined herein, or another monocyclic ring system as defined herein. Representative examples of bicyclic ring systems include but are not limited to, for example, benzimidazole, benzothiazole, benzothiadiazole, benzothiophene, benzoxadiazole, benzoxazole, benzofuran, benzopyran, benzothiopyran, benzodioxine, 1,3-benzodioxole, carbazole, cinnoline, indazole, indole, indoline, indolizine, naphthyridine, isobenzofuran, isobenzothiophene, isoindole, isoindoline, isoquinoline, phthalazine, purine, pyranopyridine, quinoline, quinolizine, quinoxaline, quinazoline, tetrahydroisoquinoline, tetrahydroquinoline, thiopyranopyridine, and the like. These rings include quaternized derivatives thereof and can be optionally substituted with one or more alkyl and/or aryl group substituents.

“Substituted heterocyclic” as used herein refers to a heterocyclic group wherein one or more hydrogen atoms are replaced by an alkyl or aryl group substituent.

The term “heteroaryl” refers to an aromatic monocyclic- or a bicyclic-ring system (a fused, bridged or spirocyclic ring system) comprising one or more heteroatoms (e.g., 1, 2, or 3 heteroatoms selected from oxygen, sulfur, and substituted or unsubstituted nitrogen, wherein N-oxides, sulfur oxides and dioxides are permissible heteroatom substitutions) inserted along the cyclic aryl carbon chain. In some embodiments, the monocyclic heteroaryl group is a five to seven-membered aromatic ring. Representative heteroaryl groups include but are not limited to, furan, thiophene, pyrrole, imidazole, pyrazole, triazole, tetrazole, oxazole, isoxazole, oxadiazole, thiaciazole, isothiazole, pyridine, pyridazine, pyrazine, pyrimidine, quinoline, isoquinoline, benzofuran, benzoxazole, benzothiophene, indole, indazole, benzimidazole, imidazopyridine, pyrazolopyrindine, and pyrazolopyrimidine.

The term “substituted heteroaryl” refers to a heteroaryl group as defined herein wherein one or more hydrogen atoms are replaced by an aryl group substituent.

“Aralkyl” refers to an aryl-alkyl- or an -alkyl-aryl group wherein aryl and alkyl are as previously described and can include substituted aryl and substituted alkyl. Thus, “substituted aralkyl” can refer to an aralkyl group comprising one or more alkyl or aryl group substituents. Exemplary aralkyl groups include benzyl, phenylethyl, and naphthylmethyl.

“Alkylene” can refer to a straight or branched bivalent aliphatic hydrocarbon group having from 1 to about 20 carbon atoms, e.g., 1, 2, 3, 4, 5, 6, 7, 8, 9, 10, 11, 12, 13, 14, 15, 16, 17, 18, 19, or 20 carbon atoms. The alkylene group can be straight, branched or cyclic. The alkylene group also can be optionally unsaturated (i.e., include alkene or alkyne groups) and/or substituted with one or more “alkyl group substituents.” There can be optionally inserted along the alkylene group one or more oxygen, sulfur or substituted or unsubstituted nitrogen atoms (also referred to herein as “alkylaminoalkyl”), wherein the nitrogen substituent is alkyl as previously described. Exemplary alkylene groups include methylene (—CH₂—); ethylene (—CH₂—CH₂—); propylene (—(CH₂)₃—); cyclohexylene (—C₆H₁₀—); —CH═CH—CH═CH—; —CH═CH—CH₂—; —(CH₂)_{q}—N(R)—(CH₂)ᵣ—, wherein each of q and r is independently an integer from 0 to about 20, e.g., 0, 1, 2, 3, 4, 5, 6, 7, 8, 9, 10, 11, 12, 13, 14, 15, 16, 17, 18, 19, or 20, and R is hydrogen or lower alkyl; methylenedioxyl (—O—CH₂—O—); and ethylenedioxyl (—O—(CH₂)₂—O—). An alkylene group can have about 2 to about 3 carbon atoms and can further have 6-20 carbons.

“Arylene” refers to a bivalent aryl group, which can be substituted or unsubstituted.

The term “aralkylene” refers to a bivalent group that comprises a combination of alkylene and arylene groups (e.g., -arylene-alkylene-, alkylene-arylene-alkylene-, arylene-alkylene-arylene-, etc.).

Similarly, the terms “cycloalkylene”, “heterocycloalkylene” and “heteroarylene” refer to bivalent cycloalkyl, heterocyclic, and heteroaryl groups, which can optionally be substituted with one or more alkyl or aryl group substitutents.

As used herein, the term “acyl” refers to an organic carboxylic acid group wherein the —OH of the carboxylic acid group has been replaced with another substituent. Thus, an acyl group can be represented by RC(═O)—, wherein R is an alkyl, substituted alkyl, aralkyl, substituted aralkyl, aryl, or substituted aryl group as defined herein. As such, the term “acyl” specifically includes arylacyl groups, such as a phenacyl group. Specific examples of acyl groups include acetyl (i.e., —C(═O)CH₃) and benzoyl.

“Alkoxyl” refers to an alkyl-O— group wherein alkyl is as previously described, including substituted alkyl. The term “alkoxyl” as used herein can refer to, for example, methoxyl, ethoxyl, propoxyl, isopropoxyl, butoxyl, t-butoxyl, and pentoxyl. The terms “oxyalkyl” and “alkoxy” can be used interchangably with “alkoxyl”.

“Aryloxyl” and “aryloxy” refer to an aryl-O— group wherein the aryl group is as previously described, including a substituted aryl. The term “aryloxyl” as used herein can refer to phenyloxyl or hexyloxyl, and to alkyl, substituted alkyl, or alkoxyl substituted phenyloxyl or hexyloxyl.

“Aralkyloxyl” or “aralkoxy” refer to an aralkyl-O— group wherein the aralkyl group is as previously described. An exemplary aralkyloxyl group is benzyloxyl.

The term “carbonyl” refers to the group —C(═O)—. The term “carbonyl carbon” refers to a carbon atom of a carbonyl group. Other groups such as, but not limited to, acyl groups, anhydrides, aldehydes, esters, lactones, amides, ketones, carbonates, and carboxylic acids, include a carbonyl group.

The terms “carboxyl” and “carboxylic acid” refer to the —C(═O)OH or —C(═O)O⁻ group. In some embodiments, the term “carboxylate” refers to the C(═O)O⁻ group.

The terms “halo” or “halogen” as used herein refer to fluoro, chloro, bromo, and iodo groups.

The term “amine” refers to a molecule having the formula N(R)₃, or a protonated form thereof, or a group having the formula —N(R)₂, wherein each R is independently H, alkyl, substituted alkyl, aryl, substituted aryl, aralkyl, substituted aralkyl, or wherein two R groups together form an alkylene or arylene group. The term “primary amine” refers to an amine wherein at least two R groups are H. The term “secondary amine” refers to an amine wherein only one R group is H. The terms “hydroxyl” and “hydroxy” refer to the —OH group.

The terms “mercapto” and “thiol” refer to the —SH group.

The term “oxo” refers to a compound described previously herein wherein a carbon atom is replaced by an oxygen atom.

The terms “bonding” or “bonded” and variations thereof can refer to either covalent or non-covalent bonding. In some cases, the term “bonding” refers to bonding via a coordinate bond. The term “conjugation” can refer to a bonding process, as well, such as the formation of a covalent linkage or a coordinate bond.

As used herein, the term “metal-organic framework” refers to a solid network (e.g., a two- or three-dimensional network) comprising both metal and organic components, wherein the organic components include at least one, and typically more than one carbon atom. In some embodiments, the metal-organic matrix material is a coordination polymer, which comprises repeating units of a coordination complex comprising a metal-based component (also referred to as a “secondary building unit” or “SBU”) and a polydentate organic ligand. Suitable SBUs include, for example, metal ions, metal clusters, and metal-oxo clusters. Suitable organic ligands include bidentate, tridentate, or other polydentate organic ligands, i.e., molecules that include at least two functional groups that can form coordination bonds to a metal. Thus, a single organic ligand can interact with, or bridge, at least two SBUs. In some embodiments, the MOF contains more than one type of SBU. In some embodiments, the MOF can contain more than one type of organic bridging ligand.

A “coordination complex” is a compound in which there is a coordination bond between a metal ion and an electron pair donor, ligand or chelating group. Thus, ligands or chelating groups are generally electron pair donors, molecules or molecular ions having unshared electron pairs available for donation to a metal ion.

The term “coordination bond” refers to an interaction between an electron pair donor and a coordination site on a metal ion resulting in an attractive force between the electron pair donor and the metal ion. The use of this term is not intended to be limiting, in so much as certain coordinate bonds also can be classified as having more or less covalent character (if not entirely covalent character) depending on the characteristics of the metal ion and the electron pair donor.

As used herein, the term “ligand” refers generally to a species, such as a molecule or ion, which interacts, e.g., binds, in some way with another species. More particularly, as used herein, a “ligand” can refer to a molecule or ion that binds a metal ion in solution to form a “coordination complex.” See Martell, A. E., and Hancock, R. D., Metal Complexes in Aqueous Solutions, Plenum: New York (1996), which is incorporated herein by reference in its entirety. The terms “ligand” and “chelating group” can be used interchangeably. The term “bridging ligand” can refer to a group that bonds to more than one metal ion or complex, thus providing a “bridge” between the metal ions or complexes. Organic bridging ligands can have two or more groups with unshared electron pairs separated by, for example, an alkylene or arylene group. Groups with unshared electron pairs, include, but are not limited to, —CO₂H, —NO₂, amino, hydroxyl, thio, thioalkyl, —B(OH)₂, —SO₃H, PO₃H, phosphonate, and heteroatoms (e.g., nitrogen, oxygen, or sulfur) in heterocycles.

The term “coordination site” when used herein with regard to a ligand, e.g., a bridging ligand, refers to an unshared electron pair, a negative charge, or atoms or functional groups cable of forming an unshared electron pair or negative charge (e.g., via deprotonation under at a particular pH).

“Embedded” can refer to an agent (e.g., an adsorbent agent) that is bound, for example covalently bound or bound via a coordinative bond, inside a porous material (e.g., a porous polymeric network or “matrix”). “Embedded” agents can be “sequestered”, “entrapped”, or “trapped” (i.e., non-covalently embedded or “encapsulated”) inside pores, cavities, or channels in a porous material or interact with components of the matrix via hydrogen bonding, London dispersion forces, or any other non-covalent interaction.

The terms “polymer” and “polymeric” refer to chemical structures that have repeating units (i.e., multiple copies of a given chemical substructure). Polymers can be formed from polymerizable monomers. A polymerizable monomer is a molecule or complex that comprises one or more moieties that can react or interact to form bonds (e.g., covalent or coordination bonds) with moieties on other molecules or complexes of the polymerizable monomer. In some embodiments, each polymerizable monomer can bond to two or more other molecules/moieties. In some cases, a polymerizable monomer will bond to only one other molecule, forming a terminus of the polymeric material.

Polymers can be organic, or inorganic, or a combination thereof. As used herein, the term “inorganic” refers to a compound or composition that contains at least some atoms other than carbon, hydrogen, nitrogen, oxygen, sulfur, phosphorous, or one of the halides. Thus, for example, an inorganic compound or composition can contain one or more silicon atoms and/or one or more metal atoms.

The term “curable” refers to a composition that can be cured, i.e., be transformed from a liquid or viscous state to a solid state. For example, the terms “cure” and “cured” can refer to joining monomers, oligomers or polymer chains together by covalent or non-covalent chemical bonds, e.g., via crosslinking molecules or groups, to form a polymeric network. As used herein, curable coating compositions can contain both a curable component (e.g., a “resin” or “binder” or “binder system”) and a non-curable component (e.g., a solid adsorbent agent and/or a solid inorganic porosity control agent). Thus, in some embodiments, crosslinking can occur via the reaction of co-reactable functional groups including via self-condensation. Crosslinking is typically temperature (i.e., thermally) activated. By “thermally activated” is meant that the crosslinking proceeds at room temperature or usually higher temperatures within a reasonable time frame (e.g., a few minutes or hours), compatible with the overall production process of the surface coverings. Alternatively, curing/crosslinking can be initiated by ultra-violet (UV) or electron (EB) irradiation.

### II. General Considerations

As noted above, coating materials and processes have gained attention recently with respect to carbon capture technology as well as in other applications involving selective adsorption/harvesting of certain molecules. There are a variety of organic and/or inorganic sorbent materials (e.g., solid organic and/or inorganic sorbent materials) known in the field which can be desirable for use in functional coatings for applications involving adsorption. Solid amine sorbents, for example, can adsorb carbon dioxide (CO₂) gas via chemisorption, binding the CO₂ gas as a carbamate. One class of solid amine-containing sorbent materials e.g., for use in adsorbing CO₂ in carbon capture and sequestration (CCS) applications, are those prepared by the reaction of polyamines with polyaldehyde phosphorous dendrimers. These materials are referred to herein more generally as “polyamine-based p-denderimers” or just “P-dendrimers”. Polyamine-based P-dendrimers and methods of their preparation are described in U.S. Pat. No. 10,994,261, the disclosure of which is incorporated herein by reference in its entirety. Many metal-organic frameworks (MOFs), solid materials comprising metal ions or clusters linked via polydentate organic ligands, can also act as adsorbent agents, e.g., for water, carbon dioxide, hydrogen sulfide (H₂S), and hydrocarbons (e.g., paraffins and aromatics). However, it can be difficult to incorporate solid adsorbent materials into compositions suitable for effectively and durably coating surfaces. For instance, because of the rubbery nature of most of organic oligomers, polymers, and dendrimers, P-dendrimer materials can be difficult to coat onto surfaces such as metal plates or papers. Cracking of solid or solidified coating materials comprising solid sorbents, with subsequent detachment from surfaces, is also a challenge.

There are several coating methods known in the art, including, but not limited to micro-arc oxidation (MAO), chemical vapor deposition (CVD), physical vapor deposition (PVD), and spray techniques. PVD, for instance, is carried out at extremely low pressure and the materials are vaporized and deposited with a metal vapor condensation, creating a thin film. To achieve a thicker coating, this process can be repeated many times. However, PVD processes involve expensive equipment and can be energy-intensive.^{1,2} CVD takes place under high vacuum and has been widely employed by semiconductor fabrication industries. CVD can involve gas-phase chemical reactions that lead to the formation of byproducts. This method can result in coatings of thicknesses in order of micrometers.^{3,4} MAO processes involve the generation of micro-arc plasma channels, melting a certain portion of the substrate surface. The oxygen inside the electrolyte can cause the oxidation of the materials, resulting in the formation of byproducts. Accordingly, not all of these methods are capable of providing coatings having a thickness in the order of millimeters to centimeters.^{5,6}

The presently disclosed subject matter provides a modular method of coating surfaces with an adsorbent coating layer, i.e., a solid coating layer comprising adsorbent agents (e.g., solid sorbent agents), such as polyamine-based P-dendrimers and/or MOFs, embedded in a polymeric network/matrix. The presently disclosed subject matter further provides curable coating compositions comprising solid adsorbent agents. The curable coating compositions described herein can optionally include additional components that can enhance the porosity of the corresponding cured coating layers. Such additional components include, for example, thermally decomposable inorganic compounds and decomposable chemical functional groups (e.g., carbamate moieties formed by bubbling carbon dioxide gas in curable coating compositions comprising polyamine-based P-dendrimers comprising reactive amine groups). The presently disclosed methods and curable coating compositions can provide for the coating (e.g., uniform, crack-free coating) of adsorbent coating layers (e.g., comprising organic dendrimers, oligomers, and polymers) on metal plates in thicknesses of up to 0.5 mm or more. Also provided are objects coated using the presently disclosed coating method and/or with the curable coating compositions of the presently disclosed subject matter (i.e., objects having at least one surface coated with a cured/solid coating layer comprising an adsorbent agent embedded in a polymeric matrix) and their use, for instance, in carbon capture (e.g., direct air capture (DAC)) or water vapor capture (e.g., atmospheric water harvesting). For example, as described below, the carbon capture capacity of polyamine-based P-dendrimer coating formulations of the presently disclosed subject matter was determined via Intelligent gravimetric analyzer (IGA), and the surface properties of the materials coated thereby were studied using scanning electron microscopy (SEM) and Brunauer-Emmett-Teller (BET) surface area analysis, as well as via CO₂ isotherm experiments. Water sorption of MOF-containing coating compositions of the presently disclosed subject matter are also described.

### III. Curable and Cured Coating Compositions

In some embodiments, the presently disclosed subject matter provides a curable coating composition comprising an adsorbent agent (e.g., a solid adsorbent agent), a liquid carrier, and a curable binder (also referred to herein as a “binder solution” or “BS”). In some embodiments, the composition can comprise a plurality of different adsorbent agents. The composition can be prepared by mixing a slurry comprising the adsorbent agent (or agents) and the liquid carrier with the curable binder. Thus, when the curable coating composition is cured, the adsorbent agent is (or the adsorbent agents are) embedded in a layer of a solid polymeric matrix formed by curing of the binder.

The term “curable binder” as used herein refers to a molecule or mixture of molecules that is/are liquid or semi-liquid (e.g., “viscous”), but which can be cured to form a solid polymeric matrix. Typically, the “curable binder” can comprise or consist of one or more “resin.” There are several classes of synthetic resins, including, but not limited to, epoxy resins, polyester resins, phenolic resins, alkyd resins, polycarbonate resins, polyamide resins, polyurethane resins, and silicone resins. When the cured resin forms part of a copolymer, the binder can include more than one monomer, oligomer, or liquid polymer that can undergo curing. In some embodiments, in binders that can be cured to form copolymers, one monomer, oligomer or liquid polymer can be referred to as the “resin” and another as a “hardener” or “curing agent.” For example, it is a common practice to refer to liquid polyglycidyl ethers of polyhydric phenols or other polyols that can be cured to form solid epoxy polymers as “epoxy resins” (although they can also be referred to as “prepolymers”). Binders comprising epoxy resins typically also include a co-monomer or co-reactant, referred to as a “hardening agent.” Suitable hardening agents for use in binders with epoxy resins include but are not limited to, polyfunctional amines, polyfunctional carboxylic acids or acid anhydrides, polyfunctional phenols, aliphatic polyols, and polyfunctional thiols.

In some embodiments, the presently disclosed curable coating composition comprises an epoxy resin, i.e., the curable binder comprises an epoxy resin. In some embodiments, the curable binder comprises a non-aromatic epoxy resin. As used herein, the term “non-aromatic epoxy resin” refers to compounds, oligomers, polymers or “prepolymers” that include a reactive epoxide group and do not include an aromatic ring. In addition to the epoxide group, the non-aromatic epoxy resin can include groups, such as, but not limited to, an alkyl group, an alkylene group, an alkoxy group, an alkenyl group, an alkenylene group, an alkynyl group, a cycloalkyl group, a cycloalkylene group, a heterocycloalkyl group, a heterocycloalkylene group, a cycloalkenyl group (e.g., a cyclic group that has a double bond in a ring thereof and is not aromatic), a cycloalkenylene group, a heterocycloalkenyl group, a heterocycloalkenylene group, and/or a non-aromatic condensed polycyclic group. The non-aromatic epoxy resin can therefore include any suitable aliphatic epoxy resin, cycloaliphatic epoxy resin, or mixture thereof. The non-aromatic epoxy resin can have one or more, such as two or more reactive epoxy groups. By “reactive epoxy groups” is meant epoxy groups that can undergo reaction with another compound, such as an amine. In some embodiments, the epoxide group of the non-aromatic resin can be bonded to another functional group via a single bond or a plurality of bonds. For example, the oxygen atom of the epoxide group can be bonded to two separate and adjacent carbon atoms of a cycloaliphatic ring, e.g., when the non-aromatic epoxy resin includes a cycloaliphatic epoxy resin.

Examples of suitable non-aromatic epoxy resins include acrylic polymers or oligomers including glycidyl methacrylate, aliphatic epoxy resins prepared from hydrogenated Bisphenol-A (e.g., EPONEX® Resin 1510, available from Hexion Inc., Columbus, Ohio, United States of America), aliphatic monoglycidyl ether (e.g., HELOXY® Modifier 8, HELOXY® Modifier 61, HELOXY® Modifier 62, HELOXY® Modifier 65, and/or HELOXY® Modifier 116, each of which is available from Hexion Inc., Columbus, Ohio, United States of America), a reaction product of reactants including epichlorohydrin and a C₁₂-C₁₄ alcohol (e.g., Dow D.E.R.™ 721, available from Dow Chemical Company, Midland, Michigan, United States of America), a reaction product of reactants including epichlorohydrin and 2-ethylhexyl alcohol (e.g., Dow D.E.R.™ 728, available from Dow Chemical Company, Midland, Michigan, United States of America), a cycloaliphatic epoxy resin (e.g., Dow D.E.R.™ 3391, available from Dow Chemical Company, Midland, Michigan, United States of America), an aliphatic liquid epoxy resin (e.g., Dow D.E.R.™ 3912, available from Dow Chemical Company, Midland, Michigan, United States of America), a reaction product of reactants including epichlorohydrin and cyclohexane-dimethanol (e.g., Dow D.E.R.™ 737, available from Dow Chemical Company, Midland, Michigan, United States of America), a reaction product of reactants including epichlorohydrin and neopentyl glycol (e.g., Dow D.E.R.™ 738, available from Dow Chemical Company, Midland, Michigan, United States of America), a reaction product of reactants including epichlorohydrin and trimethylolpropane (e.g., Dow D.E.R.™ 741, available from Dow Chemical Company, Midland, Michigan, United States of Ameria), triglycidyl ether of trimethylolpropane (e.g., HELOXY® Modifier 48, available from Hexion Inc., Columbus, Ohio, United States of America), diglycidyl ether of 1,4 butanediol (e.g., HELOXY® Modifier 67, available from Hexion Inc., Columbus, Ohio, United States of America), diglycidyl ether of neopentyl glycol (e.g., HELOXY® Modifier 68, available from Hexion Inc., Columbus, Ohio, United States of America), diglycidyl ether of cyclohexane dimethanol (e.g., HELOXY® Modifier 107, available from Hexion Inc., Columbus, Ohio, United States of America), dimer acid diglycidyl ester (e.g., HELOXY® Modifier 71, available from Momentive, Columbus, Ohio), castor oil polyglycidyl ether (e.g., HELOXY® Modifier 505, available from Momentive, Columbus, Ohio), glycerol propoxylate triglycidyl ether, a reaction product of reactants including propylene glycol and/or dipropylene glycol and epichlorohydrin (e.g., D.E.R.™ 732 and D.E.R.™® 736, available from Dow Chemical Company, Midland, Mich.), 3,4-epoxycyclohexylmethyl, 3,4-epoxycyclohexane carboxylate and bis((3,4-epoxycyclohexyl)methyl)adipate, but the present disclosure is not limited thereto. In some embodiments, the epoxy resin comprises a cycloaliphatic epoxy resin. In some embodiments, the epoxy resin is a glycidyl ether prepared from hydrogenated Bisphenol-A, such as EPONEX® 1510.

In some embodiments, the curable binder further comprises a hardening agent or co-monomer suitable for reacting with and curing the epoxy resin. In some embodiments, the curable binder comprises an amine, e.g., a diamine or other polyamine, as a hardening agent. One skilled in the art will appreciate that the amine serves to react with the epoxy functionality on the non-aromatic epoxy resin, thereby curing the coating composition. Any suitable amine can be used including, for example, an aliphatic amine, an adduct of an aliphatic amine, a cycloaliphatic amine, an amidoamine, a polyamide, a polyamide having one or more amine groups, or mixtures thereof. In some embodiments, the hardening agent can include one or more primary or secondary diamines or polyamines in which the groups attached to the amine nitrogen atoms can be saturated or unsaturated, aliphatic, alicyclic, aromatic, aromatic-substituted aliphatic, aliphatic-substituted aromatic or heterocyclic. The hardening agent can include a mixed amine in which groups attached to the amine nitrogen atoms are different. For example, the mixed amine can include aromatic and aliphatic groups. The amine can also include other non-reactive groups bonded to a carbon atom of a group attached to an amine nitrogen atom. For instance, the other non-reactive groups can include oxygen, sulfur, halogen or nitroso. Examples of suitable aliphatic and alicyclic diamines include: 1,2-ethylene diamine, 1,2-propylene diamine, isophorone diamine, propane-2,2-cyclohexyl amine, and methane-bis-(4-cyclohexyl amine). Examples of suitable commercially available amines include, but are not limited to, ANCAMINES® and ANCAMIDES® available from Evonik, Essen, Germany.; LONZACURE® hardeners available from Lonza, Basel, Switzerland; JEFFAMINE™ polyetheramines available from Huntsman, Salt Lake City, Utah, United States of America; LAROMIN™ hardeners available from BASF, Ludwigshafen, Germany; DYTEK® Idea Intermediates available from INVISTA, Wichita, Kansas, United States of America; and VERSAMINE® polyamines available from BASF, Ludwigshafen, Germany. In some embodiments, the amine hardening agent is a diamine (i.e., the curable binder comprises a diamine). In some embodiments, the diamine is an aliphatic or alicyclic diamine. In some embodiments, the diamine is a diamine of a C₃-C₁₂ alkane or a C₃-C₆ alkane. In some embodiments, the diamine is 1,3-pentanediamine.

In some embodiments, the curable binder further comprises one or more epoxy modifier, such as, but not limited to an epoxy-functionalized alcohol, an epoxy-functionalized diol, an epoxy-functionalized polyol, and an epoxy-functionalized carboxylic acid. In some embodiments, the epoxy modifier is one or more of the epoxy resins described above, such as one of those sold as epoxy modifiers with the tradename HELOXY® (available from Hexion Inc., Columbus, Ohio, United States of America).

In some embodiments, the curable binder further comprises an adhesion promoter, i.e., a multifunctional monomer or oligomer that contains functional groups that can chemically or physically interact with a substrate of interest (e.g., a metal substrate) and a functional group that can chemically or physically interact with a resin or hardening agent in the binder. In some embodiments, the adhesion promoter is an an epoxy-functionalized silane. In some embodiments, the epoxy-functionalized silane is glycidoxypropyltrimethoxysilane (GPS).

In some embodiments, the liquid carrier is an organic solvent. The liquid carrier can be provided, for instance, to aid in dispersion of the solid adsorbent material in the curable binder. In some embodiments, the liquid carrier is selected to have a boiling point that is similar (e.g., within about 10° C. or about 20° C.) to the temperature used to cure the binder and that has low reactivity with the curable binder. Suitable solvents include, but are not limited to, alkanes (e.g., cyclohexane, hexane, etc.), ethers (e.g., tetrahydrofuran (THF), dioxane, etc.), ketones (e.g., 2-butanone, acetone, methyl ethyl ketone, methyl isobutyl ketone, etc.), esters (e.g., ethyl acetate, butyl acetate), nitriles (e.g., acetonitrile), and alcohols (e.g., methanol, ethanol, propanol (e.g., isopropanol (IPA)), and butanol (e.g., 1-butanol, 2-butanol, tert-butanol, etc.). In some embodiments, the solvent is a polar organic solvent, e.g., an alcohol, acetonitrile, or ethyl acetate. In some embodiments, the liquid carrier is an alcohol. In some embodiments, the liquid carrier comprises or consists of IPA.

The adsorbent agent can comprise any solid adsorbent agent that can chemically or physically adsorb a molecule of interest (e.g., from a gas mixture). In some embodiments, the solid adsorbent agent comprises or consists of an amine-containing solid adsorbent agent. In some embodiments, the adsorbent agent is a polyamine-based P-dendrimer. As described hereinabove, this class of solid amine adsorbent agents is described in U.S. Pat. No. 10,994,261, which is incorporated herein by reference in its entirety. More particularly, polyamine-based P-denderimers are the result of crosslinking polyaldehyde-containing phosphorous dendrimer core compounds with polyethyleneimine (PEI) or another polyamine (e.g., ethylenediamine or tetraethylenepentaamine (TEPA)). The polyaldehyde-containing phosphorous dendrimer core can be a thiophosphoryl, phosphazene, or cyclophosphazatetraene compound. In some embodiments, the polyaldehyde p-dendrimer cores can be prepared by reacting a phosporous core compound that comprises P—Cl bonds with 4-hydroxybenzaldehyde (resulting in a “zero generation” (G₀) polyaldehyde-containing P-dendrimer core compound). If desired, more complex cores can be formed by reacting the G₀ core first with dichlorophosphonomethylhydrazide (which reacts with the aldehyde groups of the G₀ core to form a —C═N—N(Me)-P(═S)(Cl)₂ group; and then with 4-hydroxybenzaldehyde, which displaces the chlorides with new aldehyde-terminated phenoxy substituents, thereby forming a “G₁” dendrimer. The G₁ compounds can be further treated with one or more additional cycles of dichlorophosphonomethylhydrazide and 4-hydroxybenzaldehyde reactions to provide more complex, “higher” generation (e.g., G₂, G₃, etc.) compounds, which can increase the structural complexity and aldehyde functionality of the core. Core structures can also be linked to one another via bifunctional organic linkers, such as 4,4′-dihydroxydiphenyl.

In some embodiments, the polyamine P-dendrimer is prepared by reacting an aldehyde-containing P-dendrimer core selected from hexa(4-formylphenoxy)cyclotriphosphazene (referred to herein as “1-G₀”) and o,o,o-tris(4-formylphenyl)phosphorothioate (TPPT) (referred to herein as “2-G₀”) with a polyamine. In some embodiments, the aldehyde-containing P-dendrimer core is a higher generation core (e.g., G₁, G₂ or greater). The polyamine can include one or more polyamines selected from the group including, but not limited to, PEI (e.g., branched PEI having a molecular weight of about 600 to about 70,000), tetraethylenepentamine, triethylenebutamine, diethylenetriamine, 1,2-diaminoethane, 1,2-diaminepentane, and 2,2′,2″-triaminotriethylamine. In some embodiments, the polyamine comprises one or more polyamine selected from the group comprising MW 600 branched PEI; MW 800 branched PEI; MW 1200 branched PEI; MW 2500 branched PEI; MW 10000 branched PEI; MW 600 linear PEI; tetraethylenepentamine; triethylenebutamine; diethylenetriamine; 1,2-diaminoethane; 1,2-diaminepentane; and 2,2′,2″-triaminotriethylamine. In some embodiments, the polyamine P-dendrimer comprises 1-G₀ crosslinked with a branched PEI. In some embodiments, the polyamine P-dendrimer comprises 1-G₀ crosslinked with MW 800 branched PEI, i.e., “800PEI”.

Alternatively, in some embodiments, the solid adsorbent agent comprises or consists of an inorganic material or a material comprising both inorganic and organic components, such as a metal-organic framework (MOF). MOFs are a class of materials that comprise metal ions or clusters (e.g., metal oxo clusters) linked periodically by polydentate organic ligands to establish one-, two- or three-dimensional arrays. In some embodiments, the MOF is a crystalline, porous solid material. MOFs that can adsorb various small molecules are known in the art. The surface chemistry and structure of MOFs can be tuned for a specific application, where performance criteria such as adsorption/desorption rate, capacity as a function of pressure, and operating temperature are of interest. More particularly, in some embodiments, the size and/or shape of the MOF pores can be tailored to provide selective adsorption of different gas molecules. Thus, for instance, the MOF can act as a physisorbent to achieve adsorption of select molecules through interaction of the molecules with MOF pore surfaces. In some embodiments, e.g., for coatings that can adsorb water, the MOF comprises polydentate organic ligands comprising carboxylic acid and/or amine functional group(s). In some embodiments, the organic ligands comprise carboxylic acid groups.

Exemplary MOFs capable of adsorbing and desorbing water that can be employed in the presently disclosed coating materials include but are not limited to, those described in, for example, by Furukawa and coworkers.⁷ In some embodiments, the MOF comprises an polydentate organic ligand selected from the group comprising fumarate, 1 H-pyrazole-3,5-dicarboxylate (HPDC), isophthalate (IPA), furandicarboxylate (FDC), terephthalate (TPA), 1,3,5-benzenetricarboxylate (BTC), and methanetetrayltetrabenzoic acid (MTB). In some embodiment, the MOF comprises one or more metal ion of an element selected from the group including, but not limited to, Na, K, Li, Ca, Mg, Fe, Zn, Zr, Al, Ti, Cu, Mn, Ag, and Nb. Suitable water-adsorbent MOFs include, but are not limited to, MOF-303 (i.e., Al(OH)(HPDC)); CAU-10 (i.e., Al(OH)(IPA)); MOF-801 (i.e., Zr₆O₄(OH)₄(fumarate)₆; MOF-808 (i.e., Zr₆O₄(OH)₄(BTC)₂(HCOO)₆); MOF-841 (i.e., Zr₆O₄(OH)₄(MTB)₆(HCOO)₄(H₂O)₂); aluminum fumarate (i.e., Al(OH)(fumarate)); MIL-160 (i.e., Al(OH)(FDA)); MIL-53 (i.e., Al(OH)(TPA)); MOF-573 (i.e., [Al(OH)(C₅H₂O₄N₂)(H₂O)] constructed by linking aluminum (Ill) ions and 3,5-pyrazoledicarboxylic acid) and Aluminum Phosphate: AlPO₄-LTA. Additional MOFs that can be used include CAU-8 (i.e., an organometallic structure containing Al ion as a metal ion and benzophenone dicarboxylate as an organic ligand); HKUST-1 (MOF-199; containing a Cu ion as a metal ion and 1,3,5-benzenetricarboxylate as an organic ligand), MOF-333, which has the structure of MOF-303 except that the HPDC ligand is replaced by 2,4-furandicarboxylate (FDC); and Nb-MOF, which has the structure [Nb2(TPA)₂(naphthalenetetracarboxdiimide)]; as well as pillared MOFs, such as those described in U.S. Patent Application Publication No. 2020/0114301, the disclosure of which is incorporated herein by reference in its entirety. Exemplary pillared MOFs include but are not limited to, NbOFFIVE-1-Ni, which has the formula NiNbOF₅(pyrazine)₂; FeFFIVE-1-Ni, which has the formula NiFeF₅(pyrazine)₂; and AIFFIVE-1-Ni, which has the formula NiAlF₅(pyrazine)₂. In some variations, the MOFs have pore sizes between about 0.5 nm about 1 nm (e.g., about 0.5 nm, about 0.6 nm, about 0.7 nm, about 0.8 nm, about 0.9 nm, or about 1 nm). In some embodiments, the MOF is selected from the group comprising MOF-801, MOF-808, MOF-841, MOF-303, MOF-333, NbOFFIVE-1-Ni, FeFFIVE-1-Ni; and AlFFIVE-1-Ni. In some embodiments, the MOF is selected from MOF-801 and NbOFFIVE-1Ni. In some embodiments, the MOF is MOF-801.

In some embodiments, the curable coating composition comprises at least about 5 weight percent (wt %) of the curable binder compared to the weight of the adsorbent agent in the curable coating composition. In some embodiments, the curable coating composition comprises about 5 wt % to about 45 wt % (e.g., about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or about 45 wt %) of the curable binder compared to the weight of the adsorbent agent in the curable coating composition. In some embodiments, the curable coating composition comprises at least about 20 wt % of the curable binder (e.g., about 20 wt % to about 45 wt % of the curable binder) compared to the weight of the adsorbent agent in the curable coating composition.

In some embodiments, the curable coating composition further comprises a porosity control agent, e.g., to increase the porosity of the solid coating layer prepared by curing the curable coating. In some embodiments, the porosity control agent is a molecule or group that decomposes or otherwise reacts to form a gas. The gas can form additional pores in the cured coating as it escapes from the coating layer during the curing process. In some embodiments, the porosity control agent is an inorganic solid additive that thermally decomposes to form a gas. In some embodiments, the inorganic solid porosity control agent can be selected to be a solid that decomposes at about the same temperature as that used to cure the curable coating compositions (i.e., the cure temperature for the curable binder). For example, the porosity control agent can be a solid that decomposes at a temperature that is the same as that used to cure the curable coating composition or slightly less (e.g., within about 20° C., about 15° C., about 10° C., or about 5° C. of the curing temperature). Suitable thermally decomposable inorganic solids include, but are not limited to, ammonium carbonate, and ammonium bicarbonate. In some embodiments, the porosity control agent is one or both of ammonium carbonate and ammonium bicarbonate.

Alternatively, a thermally decomposable functional group can be incorporated into a component of the curable coating composition. For example, free/reactive amine groups in polyamine-based P-dendrimers can be transformed into thermally decomposable carbamate groups before addition of a curable by bubbling carbon dioxide gas into a slurry comprising the polyamine-based P-dendrimer. Upon heating, the carbamate groups can release carbon dioxide gas, reforming the free amine group. Free/reactive amine groups in another component of the curable coating composition, such as, for example, free/reactive amine groups in a hardener in a binder solution, can also be transformed into decomposable carbamate groups.

In some embodiments, the presently disclosed subject matter provides a solid material, e.g., a solid coating layer, that comprises an adsorbent agent (e.g., a polyamine-based P-dendrimer or MOF (e.g., water adsorbing MOF) embedded in a polymeric matrix material. In some embodiments, the adsorbent agent can include two or more different adsorbent agents. In some embodiments, the polymeric matrix material is an epoxy. In some embodiments, the coating material comprises about 55% or more of an adsorbent agent by weight (e.g., about 55% to about 95% by weight). Thus, in some embodiments, the coating material comprises about 55%, about 60%, about 65%, about 70%, about 75%, about 80%, about 85%, about 90%, or about 95% of an adsorbent agent by weight. In some embodiments, the solid material is formed by curing a curable coating composition as described herein.

In some embodiments, the presently disclosed subject provides a coated substrate (e.g., metal object) wherein one or more of the surfaces of the substrate are coated with a solid coating layer prepared by coating the surface with a curable coating composition as described herein and curing said curable coating composition. In some embodiments, the presently disclosed subject matter provides a substrate (e.g., metal object) comprising one or more surfaces coated with a solid coating layer comprising an adsorbent agent entrapped in a polymeric matrix. For example, the adsorbent agent can be a polyamine-based P-dendrimer or a MOF. In some embodiments, the polymeric matrix is an epoxy (i.e., a cured epoxy resin or binder). In some embodiments, the metal object is a metal sheet (e.g., a stainless-steel sheet). In some embodiments, the solid coating layer is porous. In some embodiments, the solid coating layer has a thickness of about 0.01 millimeters (mm) or more. In some embodiments, the solid coating layer has a thickness of about 0.01 mm to about 1.0 mm. In some embodiments, the solid coating layer has a thickness of about 0.1 mm to about 1.0 mm (e.g., about 0.1 mm, about 0.2 mm, about 0.3 mm, about 0.4 mm, about 0.5 mm, about 0.6 mm, about 0.7 mm, about 0.8 mm, about 0.9 mm, or about 1.0 mm). In some embodiments, the solid coating layer comprises about 55% or more of an adsorbent agent by weight (e.g., about 55% to about 95% by weight of an adsorbent agent).

### IV. Methods of Preparing Curable Coating Compositions and Coated Objects, and Uses Thereof

In some embodiments, the presently disclosed subject matter provides a method of preparing a curable coating composition, the method comprising: (a) preparing a slurry comprising a solid adsorbent agent and a liquid carrier; (b) preparing a curable binder; and (c) contacting the curable binder with the slurry to provide the curable coating composition. Suitable solid adsorbent agents, liquid carriers, and curable binders are described hereinabove.

In some embodiments, preparing the slurry comprises contacting the solid adsorbent agent (e.g., the polyamine-based P-dendrimer or MOF) with the liquid carrier and stirring the resulting mixture for a period of time. In some embodiments, the liquid carrier is IPA. In some embodiments, the slurry comprises a weight-to-weight ratio of solid adsorbent agent to liquid carrier of about 1:2 to about 1:3. In some embodiments, the slurry comprises a MOF and a liquid carrier (e.g., IPA) at a weight-to-weight ratio of about 1:3. In some embodiments, the slurry comprises a polyamine-based P-dendrimer and a liquid carrier (e.g., IPA) at a weight-to-weight ratio of about 1:2.

In some embodiments, preparing the curable binder comprises mixing an epoxy resin with one or more (or each of) of an epoxy modifier, a diamine or other hardening agent, and an epoxy-functionalized silane or other adhesion promoter. Mixing can be performed with a vortex mixer or other mixing apparatus. In some embodiments, the mixing is performed for about 15 seconds to about 5 minutes (e.g., about 15 seconds, about 30 seconds, about 60 seconds, 90 seconds, about 120 seconds, about 180 seconds, about 240 seconds, or about 300 seconds). Suitable resins, modifiers, hardening agents, and adhesion promoters are described hereinabove. In some embodiments, contacting the curable binder with the slurry comprises adding the curable binder to the slurry and stirring the resulting composition for a period of time (e.g., about 10 minutes, about 30 minutes, about 45 minutes, about 60 minutes, about 90 minutes, about 2 hours, about 4 hours, or the like). Mixing can be performed with a vortex mixer or other mixing apparatus. In some embodiments, the contacting of step (c) comprises contacting the slurry with an amount of curable binder having a weight of at least about 5% (e.g., about 5% to about 45%) of the weight of the solid adsorbent agent in the slurry. In some embodiments, the curable binder has a weight of about 5%, about 10%, about 15%, about 20%, about 25%, about 30%, about 35%, about 40%, or about 45% of the solid adsorbent agent.

In some embodiments, the method further comprises incorporating a porosity control agent in the curable coating composition. For example, when the porosity control agent comprises an inorganic solid additive that thermally decomposes (e.g., ammonium carbonate and/or ammonium bicarbonate) to form a gas, incorporating the porosity control agent can comprise adding the inorganic solid additive to the curable coating composition in step (c). Alternatively, the porosity control agent can be added to the slurry in step (a) or to the binder in step (b). In some embodiments, the porosity control agent is an inorganic solid additive that thermally decomposes to release carbon dioxide gas. The porosity control agent such as ammonium bicarbonate or ammonium carbonate can range from about 1 wt. % to about 5 wt. % (e.g., about 1 wt. %, about 2 wt. %, about 3 wt. %, about 4 wt. %, or about 5 wt. %) with respect to the adsorbent.

In some embodiments, the porosity control agent comprises carbamate groups that can decompose to form carbon dioxide gas and an amine group. The carbamate groups can be incorporated into the curable coating compositions by bubbling carbon dioxide gas into a composition comprising a polyamine-based P-dendrimer that comprises free/reactive amine groups (e.g., primary amine groups) or to a binder solution comprising a component (e.g., a hardener) that comprises free/reactive amine groups. Thus, in some embodiments, incorporating a porosity control agent comprises bubbling carbon dioxide gas into the slurry in step (a); wherein the carbon dioxide reacts with reactive amine groups in a polyamine-based P-dendrimer adsorbent agent to form carbamate groups that can decompose to reform carbon dioxide gas upon heating to a temperature suitable for curing the curable binder solution. In some embodiments, incorporating a porosity control agent comprises bubbling carbon dioxide gas into a curable binder in step (b) or during the contacting of step (c). Carbamate groups can also be formed when another porosity control agent (e.g., a thermally decomposable inorganic solid additive, such as ammonium carbonate or ammonium bicarbonate) decomposes to provide carbon dioxide gas that can form carbamate groups with a reactive amine group in the curable binding solution (e.g., a polyamine-based P-dendrimer or another component, such as an amine-containing hardener).

In some embodiments, the presently disclosed subject matter provides a method of coating an object (e.g., a metal object), the method comprising: (i) providing a curable coating composition as described hereinabove; (ii) pre-treating one or more surfaces of an object (e.g., a metal object) to provide one or more pre-treated surfaces, wherein the pre-treating comprises at least one of cleaning, treating with an abrasive, and/or applying a primer; (iii) applying the coating composition to the one or more prepared surfaces, thereby providing one or more treated surfaces; and (iv) curing said curable coating composition, thereby providing a metal object comprising one or more surfaces comprising a solid coating layer. In some embodiments, the pre-treating comprises washing said one or more surfaces of said object (e.g., said metal object) with an organic solvent, such as acetone and/or IPA. In some embodiments, the pre-treating comprises applying a primer to said one or more surfaces of said metal object. The primer can be, for instance, a commercially available epoxy primer (e.g., such as that sold under the tradename RUST-OLEUM® (Rust-Oleum Corporation, Vernon Hills, Illinois, United States of America)). The pre-treating can further comprise curing the primer. In some embodiments, curing the primer provides a surface with free hydroxyl groups. Alternatively, in some embodiments, the pre-treating can be omitted.

Step (iii) can be performed via any suitable technique, e.g., painting the curable coating composition on the pre-treated surface, pouring the curable coating composition onto the surface, applying the curable coating composition via doctor blade, or spin-coating. The method of curing in step (iv) can depend upon the type of curable binder used in the curable coating solution. In some embodiments, the curing comprises heating the object or the surface of the object (e.g., by placing the object in an oven). In some embodiments, the curing is performed by heating the one or more treated surfaces to a temperature of about 60° C. to about 130° C. (e.g., about 60° C., 70° C., 80° C., 90° C., 100° C., 110° C., 120° C. or about 130° C.) for about 30 minutes to about 5 hours (e.g., about 30 minutes, about 1 hours, about 2 hours, about 3 hours, about 4 hours, or about 5 hours).

In some embodiments, the object is a metal object. In some embodiments, the metal object is a metal sheet or plate. In some embodiments, the metal object comprises or consists of stainless-steel (e.g., can be a stainless-steel sheet or plate). However, the object can have any shape, including irregular shapes.

The coated objects prepared herein can have a variety of uses, e.g., in purifying, recovering or separating various gases. The particular use of a coated object can be based on the selectivity of the adsorbent agent present in the solid/cured coating layer.

In some embodiments, the presently disclosed subject matter provides a method of adsorbing carbon dioxide from a gaseous fluid (e.g., from air, optionally at a particular location near a site of high carbon dioxide release). In some embodiments, the method comprises contacting a gaseous fluid (e.g., air) comprising carbon dioxide with a coated object, wherein the coated object comprises a metal object comprising one or more surfaces comprising a solid coating layer, said solid coating layer comprising a polyamine-based P-dendrimer encapsulated in a polymeric matrix (e.g., an epoxy). In some embodiments, the metal object is a metal sheet or plate. In some embodiments, the metal object is a stainless-steel sheet or plate. In some embodiments, the polymeric matrix comprises an epoxy. In some embodiments, the solid coating layer has a thickness of at least about 0.01 mm. In some embodiments, the solid coating layer has a thickness of about 0.01 mm to about 1.0 mm. In some embodiments, the solid coating layer has a thickness of about 0.1 mm to about 1.0 mm (e.g., about 0.1, 0.2, 0.3, 0.4, 0.5, 0.6, 0.7, 0.8, 0.9, or about 1.0 mm). In some embodiments, the solid coating layer comprises about 55% or more (e.g., about 55% to about 95%) by weight of the polyamine-based P-dendrimer. In some embodiments, the polyamine-based P-dendrimer is formed by crosslinking 1-G₀ with 800PEI. In some embodiments, the polyamine-based P-dendrimer in the solid coating layer has a CO₂ adsorption capacity of about 78% compared to a same amount of free polyamine-based P-dendrimer (i.e., the same amount of the same polyamine-based P dendrimer, except not embedded in a polymeric matrix).

In some embodiments, the presently disclosed subject matter provides a method of adsorbing water (i.e., water vapor) from a gaseous fluid (e.g., air). In some embodiments, the method comprises: (i) providing a metal object comprising one or more surfaces comprising a solid coating layer, said solid coating layer comprising a MOF (i.e., a water-adsorbing MOF) encapsulated in a polymeric matrix (e.g., an epoxy); (ii) heating the metal object to about 100° C. under a nitrogen environment (e.g., to release any previously adsorbed water); and (iii) contacting a gaseous fluid comprising water vapor with the metal object. In some embodiments, the MOF is selected from the group comprising MOF-801, MOF-808, MOF-841, MOF-303, MOF-333, NbOFFIVE-1-Ni, FeOFFIVE-1-Ni, and AlOFFIVE-1-Ni. The water adsorption capacity of the coating layer can vary depending on the thickness of the layer, the amount of MOF loading, and the relative humidity (RH). In some embodiments, the water adsorption capacity of the coating layer can be about 20% on a weight-by-weight basis compared to the weight of MOF in the coating layer to about 50% on a weight-by-weight basis compared to the weight of MOF in the coating layer (e.g., about 20%, about 25%, about 30%, about 35%, about 40%, about 45%, or about 50% on a weight-by-weight basis compared to the weight of MOF). In some embodiments, the MOF is MOF-801 and the coating layer has a water adsorption capacity of about 20% on a weight-by-weight basis compared to the weight of MOF in the coating layer (e.g., at 75% RH). In some embodiments, the method further comprises recovering the water adsorbed in the containing step of claim (iii), e.g., by heating the metal object to release the adsorbed water and cooling the adsorbed water to condense it to form liquid water.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Carbon Capture Coatings

### Curable Coating Composition Preparation:

In a 250 mL round bottom flask fitted with a magnetic stirrer was added 6 grams of P-dendrimer adsorbent. The flask was added with 12 grams of isopropanol (IPA) and was stirred for 2 hours at room temperature. This resulted in a smooth p-dendrimer slurry.

For a standard epoxy-based binder solution (BS) preparation, 2.67 grams of a low to medium viscosity epoxy resin sold under the tradename EPONEX® 1510 (Hexion Inc., Columbus, Ohio, United States of America), 0.874 grams of a glycidyl ether epoxy modifier sold under the tradename HELOXY® 67 (Hexion Inc., Columbus, Ohio, United States of America), 0.489 grams of 1,3-pentanediamine (sold under the tradename DYTEK® EP (INVISTA, Wichita, Kansas, United States of America)), and three drops of glycidoxypropyl silane (3-GPS) were mixed in a 20 mL glass vial and stirred for 30 seconds using a vortex mixture.

The coating composition was made by adding BS (30% by wt. of P-dendrimer) to the P-dendrimer slurry. The thus obtained curable coating composition was allowed to stir for another 45 minutes. Curable coating compositions containing 15%, 20% and 45% BS were made via the same method, only changing the amount of BS to provide the desired % by weight with respect to the P-dendrimer.

### Metal Plate Preparation:

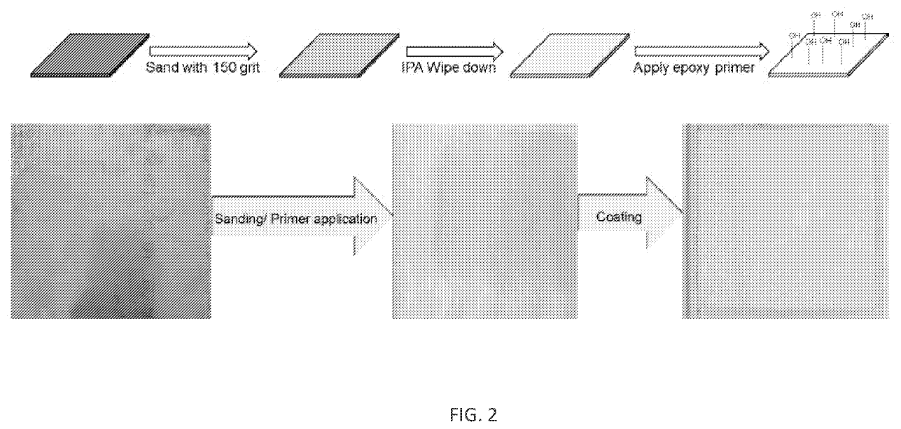

A 6′λ6′ stainless steel plate was purchased from McMASTER-CARR (Elhurst, Illinois, United States of America; part number 8983K115) and prepared for coating as shown at the top of FIG. 2. The thin plastic protective layer was taken off and the surface was cleaned by mechanical abrasion. The plate was washed with IPA and acetone. The plate was allowed to dry under air for 10 minutes. To promote the adhesion properties of the metal plate, it was coated with a white primer sold under the tradename RUST-OLEUM® (Rust-Oleum Corporation, Vernon Hills, Illinois, United States of America), dried in air for 10 minutes and cured at 120° C. for another 10 minutes. The plate was cooled down to room temperature before applying the curable coating composition. See FIG. 2, bottom.

### Coating:

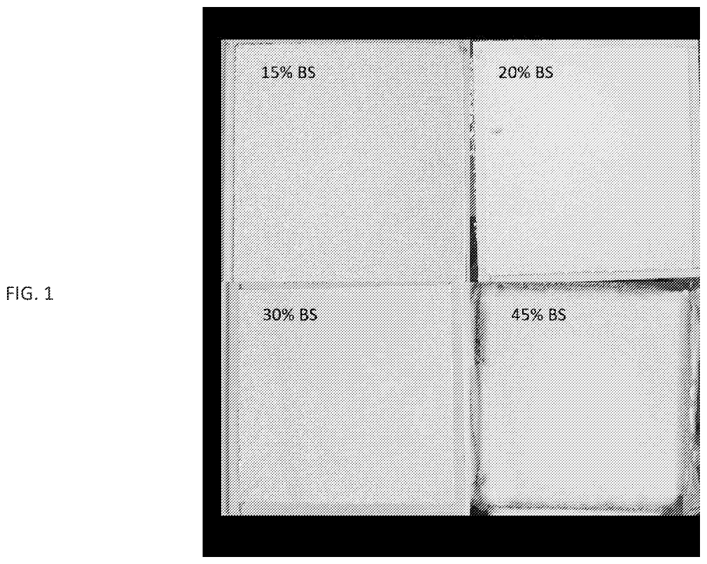

The curable coating composition was applied uniformly on the surface pretreated metal plate using a Doctor Blade. The plate was dried slowly under air and IPA vapor. After the coating composition became dry and intact, it was cured at 120° C. for 1.5 hours to get a crack-free coating. The quality of the coating was determined by a tape test. FIG. 1 shows plates coated with p-dendrimer curable coating compositions containing 15%, 20%, 30%, and 45% BS. Out of four different coating formulations, the one with 30% BS is found to be a formulation containing the least amount of BS to afford crack-free coating which passes the tape test.

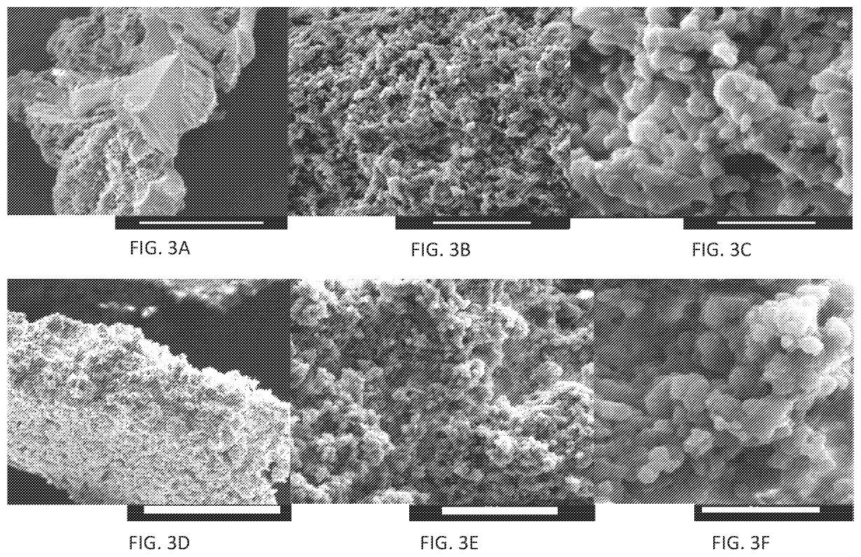

The surface structure of the curable coating composition was studied by SEM. SEM revealed that the rough surface arising from the globular structure of the P-dendrimer (see FIGS. 3A-3C) was retained in the coating composition, showing a porous network. See FIGS. 3D-3F.

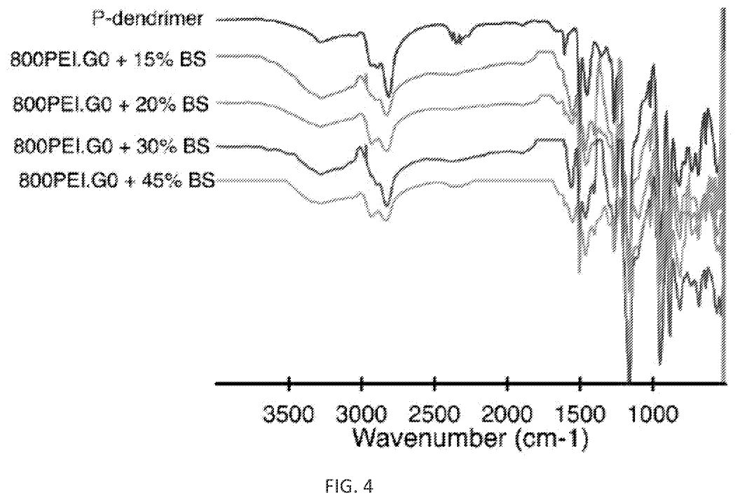

Chemical characterizations of the coating compositions were carried out using infrared (IR) spectroscopy. All of the coating compositions retained the characteristic peaks present in the P-dendrimers in their IR spectra. See FIG. 4. The chemical compositions of the P-dendrimer and coating composition containing 30% BS were studied using elemental analysis. The elemental analysis of the coating composition was found to be 46.035% C, 12.431% N, and 7.489% H while the composition of P-dendrimer alone was 50.035% C, 17.204% N, and 8.234% H. This indicates that the coating composition retains 72.27% of the nitrogen (N)-content of the parent P-dendrimer.

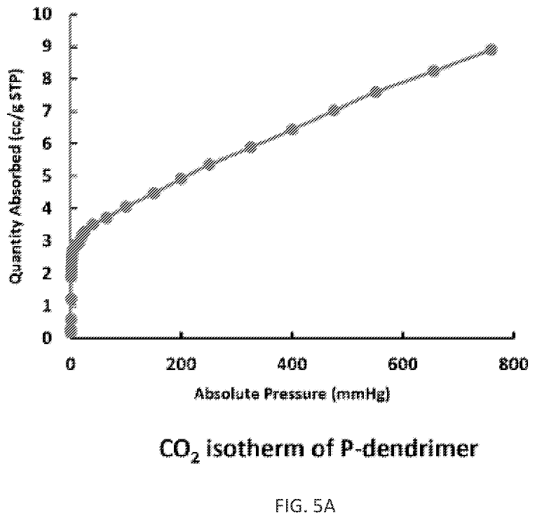

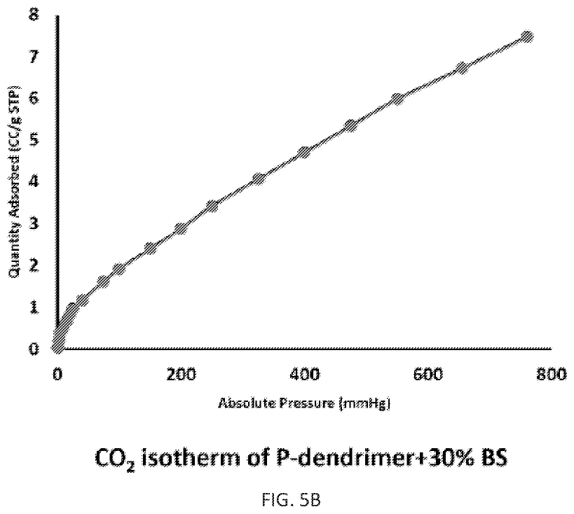

The porous structure of the P-dendrimer and of the coating compositions were studied using an Accelerated Surface Area and Porosimetry system (sold under the tradename ASAP™ 2020 V4.03; Micromeritics Instrument Corporation, Norcross, Georgia, United States of America). For both materials, the adsorption capacity increases with an increase in absolute pressure showing the exothermic nature of adsorption. See FIGS. 5A and 5B.

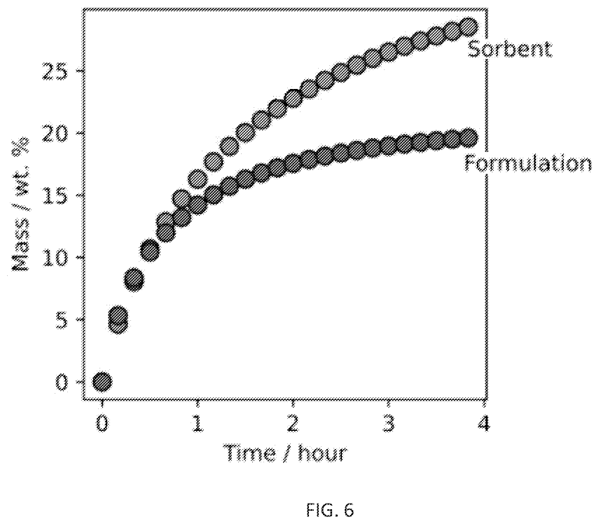

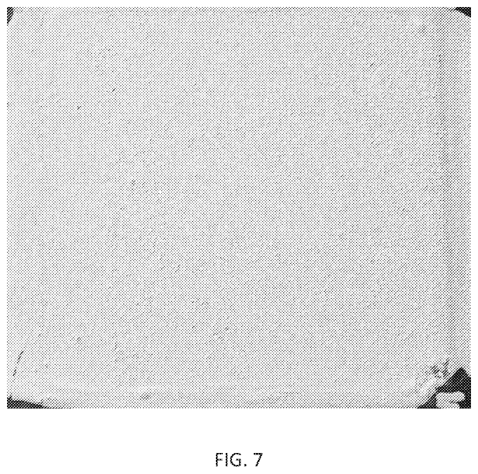

The carbon capture capacity of the P-dendrimer and formulation were measured using Intelligent gravimetric analysis (IGA). The tests were done with adsorption being carried out at 20° C., with 400 parts-per-million (ppm) CO₂ gas in air at 75% relative humidity (RH) with 300 standard cubic centimeters per minute (sccm) flow rate and the desorption was carried out at 80° C. with dry N₂ gas for 150 minutes. The amount of CO₂ adsorbed by pristine p-dendrimer was 1.62 wt. % CO₂/g after 0.5 hours under the aforementioned conditions which reached 4.39 wt. % CO₂/g after 8 hours. The curing composition could adsorb 1.75 wt. % CO₂/g of the sorbent in 0.5 hours, reaching 3.44 wt. % CO₂/g of sorbent after 8 hours, which is 78% of that of pristine sorbent. See Table 1, below. See also, FIG. 6.

TABLE 1
Comparative CO₂ Uptake Capacity of Pristine
Sorbent and Composition Containing 30% BS.

| Time | Wt. % CO₂/g | Wt % CO₂/g (formulation |
|---|---|---|
| (hour) | (sorbent) | with 30% BS) |
| 0.5 | 1.62 | 1.75 |
| 1 | 2.49 | 2.39 |
| 2 | 3.46 | 3.14 |
| 4 | 4.39 | 3.44 |

### Example 2

### Porosity Control

The direct air capture (DAC) performance of materials coated on a surface can be related to the porous nature of the coating. Porous materials provide for faster diffusion of gases (e.g., air) into the coating, providing a larger surface area for the gas-adsorbent interaction and leading to an improved adsorption capacity. Accordingly, enhancing coating porosity can be desirable. To introduce additional porosity into the presently disclosed coatings, porosity control agents were added to the coating compositions. For instance, the porosity control agents included agents that thermally decompose to form gases. Desirable porosity control agents include compounds that do not chemically react with the adsorbent agent in the composition and agents that decompose at temperatures used during curing of the coatings.

Screening of chemical substances of varying decomposition temperatures was performed. Additives with moderate decomposition temperature, such as ammonium carbonate, were found to perform well, e.g., in a composition containing 40% BS, affording a crack-free coating passing the tape test upon curing at two different temperatures. See Table 2, below. See also FIG. 7.

TABLE 2
Screening Solid Additives for Porosity Enhancement.

| | | | Amount BS | Curing | | |
|---|---|---|---|---|---|---|
| | | | (% wt/wt | Temp. | | |
| Sample | | Decomposition | w.r.t. | (° C.), | | Tape |
| Number | Additive | Temp. (° C.) | p-dendrimer | Time (h) | Cracking | Test |
| 3 | Ammonium bicarbonate | 36 | 30 | 100, 1 | N | F |
| 4 | Ammonium carbonate | 58 | 30 | 100, 1 | N | F |
| 5 | Ammonium bicarbonate | 36 | 35 | 100, 1 | N | F |
| 6 | Ammonium bicarbonate | 36 | 40 | 65, 4 | N | F |
| 7 | Ammonium bicarbonate | 36 | 40 | 100, 1 | N | F |
| 8 | Ammonium carbonate | 58 | 35 | 100, 1 | N | F |
| 9 | Ammonium carbonate | 58 | 40 | 100, 1 | N | P |
| 10 | Ammonium carbonate | 58 | 40 | 65, 4 | N | P |

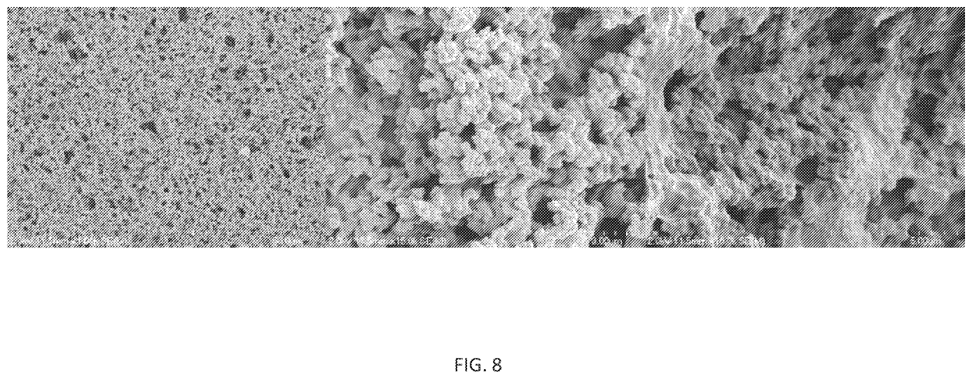

Another approach for porosity control is pre-saturation of the adsorbent coating composition with carbon dioxide gas. This provides for the in-situ formation of carbamate linkages by the reaction of free amine groups in the P-dendrimer adsorbent agents with the gaseous carbon dioxide. Upon curing of the coating composition (e.g., after application of the coating composition to a surface), the carbamate bonds decompose to provide gaseous carbon dioxide and free amine groups, regenerating the active adsorbent (i.e., the p-dendrimer). For example, the carbon dioxide gas can be bubbled into the isopropanol (IPA) solution of p-dendrimer prior to addition of the BS. Formation of decomposable carbamates via bubbling carbon dioxide gas is economical and provides coatings that show improved porosity compared to coatings prepared without pre-saturation of the p-dendrimer solution with carbon dioxide gas, as evidenced by SEM images. See FIG. 8.

### Example 3

### Water Adsorbing Coatings

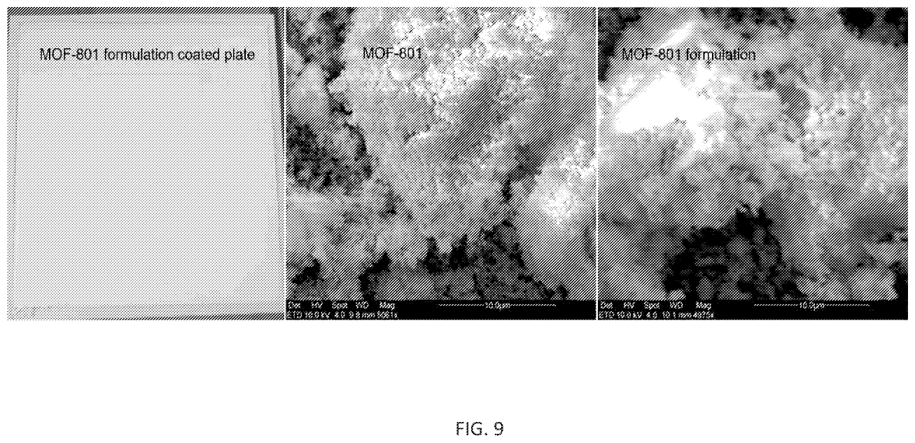

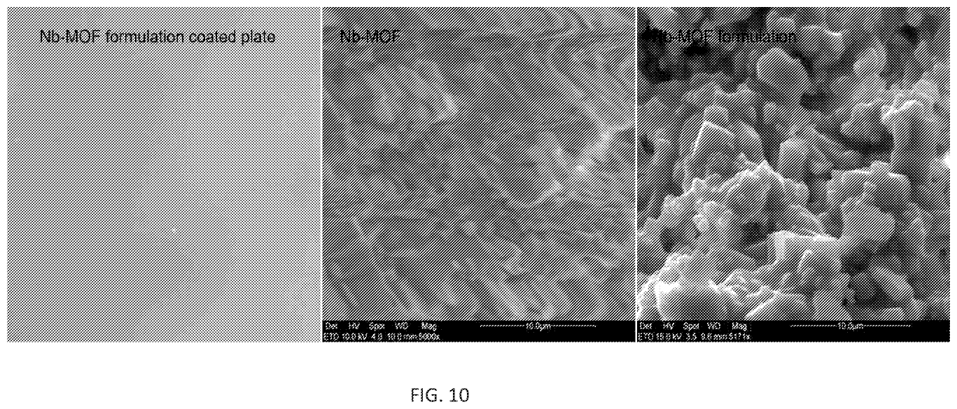

Coatings were prepared that can adsorb water from the air using a method similar to that described in Example 1 for preparing carbon capture coatings. More particularly, coating formulations were prepared that replaced the p-dendrimer adsorbent agent with a MOF. For example, coatings containing MOF-801 or Nb MOF (prepared as previously described^{8,9}) were prepared on metal plates precoated with primer for atmospheric water harvesting. In a typical procedure, a slurry of MOF in IPA (1:3 by wt.) was stirred for 2 hours, after which epoxy-based BS was added (30% w.r.t. MOF) and stirred for another 45 minutes. The resulting MOF formulation was cast on a 6′×6′ metal plate precoated with primer, followed by air drying for 2 hours and curing at 80° C. for 2 hours. Cured coatings had thicknesses up to 1 millimeters (mm), holding 8 grams of the MOF. The quality of the coating was determined with the tape test. Images of coated plates, SEM images of the coating compositions, and of pristine MOFs are shown in FIGS. 9 and 10.

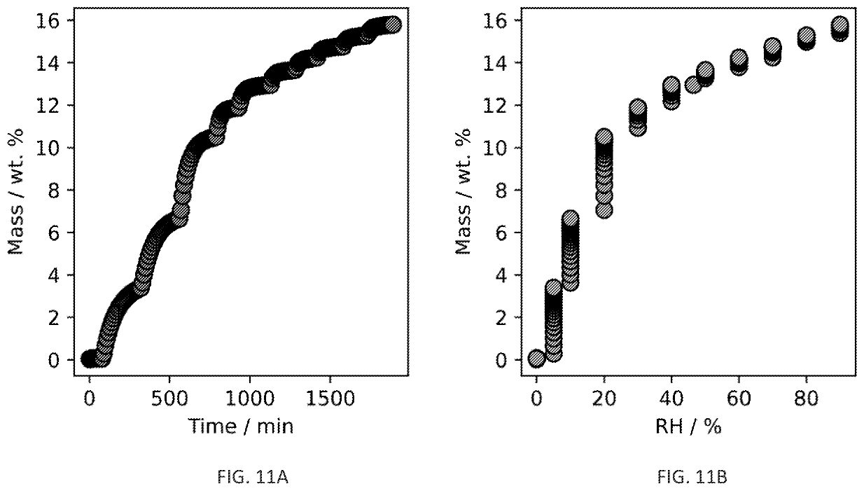

The water adsorption capacity of the MOF-801 coating composition was studied using an IGA instrument taking 100 milligrams (mg) of coating composition (preactivated by heating at 80° C. under a nitrogen environment) at 283 K in a RH range of 5% RH to 75% RH. See FIGS. 11A and 11B. Water vapor was generated using dynamic flow of dry and wet nitrogen streams with a total flow rate of 300 sccm. The RH was increased from dry conditions in a fixed interval of 5, 10, 20, 30, 40, 50, 60, 70, 80, 90, and 95%. An increase in mass was recorded at each pressure interval and equilibrium was assumed to have been reached once the change in mass over the change in time was less than +/−0.001 mg/min for 60 seconds. Under these conditions, the water adsorption capacity of the coating composition was found to be 20% wt./wt. at 75% RH.

### REFERENCES

All references listed in the instant disclosure, including but not limited to all patents, patent applications and publications thereof, scientific journal articles, and database entries, are incorporated herein by reference in their entireties to the extent that they supplement, explain, provide a background for, and/or teach methodology, techniques, and/or compositions employed herein. The discussion of the references is intended merely to summarize the assertions made by their authors. No admission is made that any reference (or a portion of any reference) is relevant prior art. Applicants reserve the right to challenge the accuracy and pertinence of any cited reference.
1. Klokholm, E.; Berry, B. S. Intrinsic Stress in Evaporated Metal Films. J. Electrochem. Soc. 1968, 115 (8), 823.
2. D'Heurle, F. M. Aluminum Films Deposited by Rf Sputtering. Metall. Mater. Trans. B 1970, 1 (3), 725-732.
3. I. On Electrostriction. Proc. R. Soc. Lond. 1878, 26 (179-184), 504-512.
4. Thornton, J. A.; Hoffman, D. W. Stress-Related Effects in Thin Films. Thin Solid Films 1989, 171 (1), 5-31.
5. Abadias, G.; Chason, E.; Keckes, J., Sebastiani, M.; Thompson, G. B.; Barthel, E.; Doll, G. L.; Murray, C. E.; Stoessel, C. H.; Martinu, L. Review Article: Stress in Thin Film Coatins: Current Status, Challenges, and Prospects. J. Vac. Sci. Technol. Vac. Surf. Films 2018, 36 (2), 020801.
6. Yerokhin, A. L.; Nie, X.; Leyland, A.; Matthews, A. Characterization of Oxide Films Produced by Plasma Electrolytic Oxidation of a Ti-6Al-4V Alloy. Surf. Coat. Technol. 2000, 130 (2-3), 195-206.
7. Furukawa, H.; Gandara, F.; Zhang, Y—B.; Jiang, J.; Queen, W. L.; Hudson, M. R.; Yaghi, O. M. Water Adsorption in Porous Metal-Organic Frameworks and Related Materials. J. Am. Chem. Soc. 2014, 136, 4369-4381.
8. Fathieh, F.; Kalmutzki, M. J.; Kapustin, E. A.; Waller, P. J.; Yang, J.; Yaghi, O. Practical Water Production from Desert Air. Sci. Adv. 2018, 4, eaat3198.
9. Bhatt, P. M.; Belmabkhout, Y.; Cadiau, A.; Adil, K.; Shekhah, O.; Shkurenko, A.; Barbour, L. J.; Eddaoudi, M. A Fine-Tuned Fluorinated MOF Addresses the Needs for Trace CO₂ Removal and Air Capture Using Physisorption. J. Am. Chem. Soc. 2016, 138, 9301-9307.

It will be understood that various details of the presently disclosed subject matter can be changed without departing from the scope of the presently disclosed subject matter. Furthermore, the foregoing description is for the purpose of illustration only, and not for the purpose of limitation.

1. A curable coating composition comprising:
(a) a solid adsorbent agent;
(b) a liquid carrier, wherein the liquid carrier is a polar organic solvent; and
(c) a curable binder comprising an epoxy resin.

2. (canceled)

3. (canceled)

4. The curable coating composition of claim 1, wherein the curable binder further comprises a diamine.

5. The curable coating composition of claim 1, wherein the curable binder further comprises an epoxy modifier selected from the group consisting of an epoxy-functionalized alcohol, an epoxy-functionalized diol, an epoxy-functionalized polyol, and an epoxy-functionalized carboxylic acid.

6. The curable coating composition of claim 1, wherein the curable binder further comprises an epoxy-functionalized silane.

7. (canceled)

8. (canceled)

9. The curable coating composition of claim 1, wherein the solid adsorbent agent is a polyamine-based phosphorous dendrimer (P-dendrimer).

10. The curable coating composition of claim 1, wherein the polyamine-based P-dendrimer is based on a polyamine selected from the group consisting of molecular weight (MW) 800 branched polyethyleneimine (PEI); MW 600 branched PEI; MW 1200 branched PEI; MW 2500 branched PEI; MW 10000 branched PEI; MW 600 linear PEI; tetraethylenepentamine; triethylenebutamine; diethylenetriamine; 1,2-diaminoethane; 1,2-diaminopropane; and 2,2′,2″-triaminotriethylamine.

11. The curable coating composition of claim 1, wherein the solid adsorbent agent is a metal-organic framework (MOF).

12. (canceled)

13. The curable coating composition of claim 1, wherein the curable coating composition comprises at least about 5 weight percent (wt %) of the curable binder compared to the weight of the solid adsorbent agent.

14. (canceled)

15. The curable coating composition of claim 1, further comprising a porosity control agent.

16-18. (canceled)

19. A method of preparing a curable coating composition, the method comprising:
(a) preparing a slurry comprising a solid adsorbent agent and a liquid carrier;
(b) preparing a curable binder, wherein preparing the curable binder comprises mixing an epoxy resin with one or more of an epoxy modifier, a diamine, and an epoxy-functionalized silane; and
(c) contacting the curable binder with the slurry to provide the curable coating composition.

20. The method of claim 19, wherein preparing the slurry comprises contacting the solid adsorbent agent with the liquid carrier and stirring the resulting mixture for a period of time.

21. The method of claim 19, wherein the slurry comprises a weight-to-weight ratio of solid adsorbent agent to liquid carrier of about 1:2 to about 1:3.

22. (canceled)

23. The method of claim 19, wherein contacting the curable binder with the slurry comprises adding the curable binder to the slurry and stirring the resulting composition for a period of time.

24. The method of claim 19, wherein the contacting comprises contacting the slurry with an amount of curable binder having a weight of at least about 5% of the weight of the solid adsorbent agent in the slurry.

25. The method of claim 19, further comprising incorporating a porosity control agent in the curable coating composition.

26. (canceled)

27. (canceled)

28. A method of coating a metal object, the method comprising:
(i) providing a curable coating composition of claim 1;
(ii) pre-treating one or more surfaces of a metal object to provide one or more pre-treated surfaces, wherein the pre-treating comprises cleaning, treating with an abrasive, and/or applying a primer;
(iii) applying the coating composition to the one or more pre-treated surfaces, thereby providing one or more treated surfaces; and
(iv) curing said curable coating composition, thereby providing a metal object comprising one or more surfaces comprising a solid coating layer.

29. The method of claim 28, wherein step (ii) comprises washing said one or more surfaces of said metal object with acetone and/or isopropanol.

30. The method of claim 28, wherein step (ii) comprises applying a primer to said one or more surfaces of said metal object, optionally wherein the primer is an epoxy primer, and curing the primer.

31. The method of claim 28, wherein step (iv) is performed by heating the one or more treated surfaces to a temperature of about 60° C. to about 130° C. for about 30 minutes to about 5 hours.

32. The method of claim 28, wherein the metal object is a metal sheet or plate, optionally a stainless-steel sheet or plate.

33-44. (canceled)
